(19) United States
(12) Patent Application Publication
(10) Pub. No.: US 2026/0296006 A1
(43) Pub. Date: Oct. 1, 2026

(54) LIQUID EJECTION HEAD AND LIQUID EJECTION DEVICE

(71) Applicant: RISO Technologies Corporation, Tokyo (JP)

(72) Inventor: Yasuhito KIJI, Mishima Shizuoka (JP)

(21) Appl. No.: 19/457,085

(22) Filed: Jan. 22, 2026

(30) Foreign Application Priority Data
Mar. 28, 2025 (JP) 2025-056827

(51) Int. Cl. B41J 2/045; B41J 2/14

(52) U.S. Cl. CPC B41J 2/04588; B41J 2/04541; B41J 2/04548; B41J 2/0455; B41J 2/04573; B41J 2/04581; B41J 2/04596; B41J 2/14233; B41J 2002/14491

(57) ABSTRACT

A liquid ejection head includes a nozzle plate having a nozzle through which liquid is ejected, a pressure chamber communicating with the nozzle, an actuator configured to change a volume of the chamber in response to a drive signal, and a drive circuit configured to generate the signal. The drive signal includes two ejection waveforms including first and second ejection waveforms, and a suppression waveform between the ejection waveforms and suppresses residual vibration generated by the first ejection waveform. The second ejection waveform is input at a timing at which vibration generated by the first ejection waveform and vibration generated by the suppression waveform intensify each other. A speed of a droplet ejected by the second ejection waveform is greater than a speed of a droplet ejected by the first ejection waveform.

### CROSS-REFERENCE TO RELATED APPLICATION

This application is based upon and claims the benefit of priority from Japanese Patent Application No. 2025-056827, filed on Mar. 28, 2025, the entire contents of which are incorporated herein by reference.

### FIELD

Embodiments described herein relate generally to a liquid ejection head and a liquid ejection device.

### BACKGROUND

In the related art, as a liquid ejection head, a technique for ejecting droplets of ink or the like is known. The liquid ejection head continuously ejects a plurality of droplets to increase a dot diameter when the droplets land on a medium, thereby realizing gradation expression of ink density on the medium.

However, when the liquid to be ejected has a low viscosity, the shape of the meniscus is disturbed in the process of continuously ejecting a plurality of droplets, and ejection failure occurs due to the entrainment of air bubbles or the like, which causes deterioration of printing quality.

In addition, when there is variation in the main acoustic vibration periods of a plurality of pressure chambers, if the same drive waveform (a drive waveform in which the ejection waveform widths for the first drop differs from that for the last drop) is input to the plurality of pressure chambers and a plurality of droplets are continuously ejected, the continuously ejected droplets may not merge, causing deterioration of printing quality.

### BRIEF DESCRIPTION OF THE DRAWINGS

FIG. 1 is a cross-sectional view of a liquid ejection head according to an embodiment.

FIG. 2 is a cross-sectional view of the liquid ejection head.

FIG. 3 is a block diagram of a drive circuit for the liquid ejection head.

FIG. 4 is a block diagram of a liquid ejection device according to an embodiment.

FIG. 5 is a diagram illustrating an example of a drive waveform including a boost waveform and an ejection waveform for ejecting three droplets.

FIG. 6 is a diagram illustrating an example of the drive waveform.

FIG. 7 is a diagram illustrating an example of a drive waveform including an ejection waveform for ejecting two droplets, a boost waveform, and a cancellation waveform.

FIG. 8 is a diagram illustrating an example of the drive waveform.

FIG. 9 is a diagram illustrating an example of a drive waveform including a cancellation waveform and an ejection waveform for ejecting one droplet.

FIG. 10 is a diagram illustrating an example of a drive waveform including a boost waveform and an ejection waveform for ejecting three droplets.

FIG. 11 is a diagram illustrating an example of a drive waveform including an ejection waveform for ejecting two droplets, a boost waveform, and a cancellation waveform.

FIG. 12 is a diagram illustrating an example of a drive waveform including a cancellation waveform and an ejection waveform for ejecting one droplet.

FIG. 13A to FIG. 13D are diagrams illustrating examples of a relationship between waveform widths of an ejection waveform and a boost waveform and the amplitude of pressure vibration generated in a pressure chamber.

FIG. 14A to FIG. 14D are diagrams illustrating examples of the relationship.

FIG. 15A and FIG. 15B are diagrams illustrating examples of the relationship.

FIG. 16A to FIG. 16D are diagrams illustrating examples of the relationship.

FIG. 17 is a diagram illustrating an example of a drive waveform and acoustic vibration.

### DETAILED DESCRIPTION

Provided are a liquid ejection head and a liquid ejection device that can reduce disturbance of the shape of a meniscus even when ejecting a plurality of droplets.

In general, according to one embodiment, a liquid ejection head comprises a nozzle plate having a nozzle through which liquid is ejected; a pressure chamber communicating with the nozzle; an actuator configured to change a volume of the pressure chamber in response to a drive signal; and a drive circuit configured to generate the drive signal. The drive signal includes: two ejection waveforms for causing the nozzle to eject two droplets, the ejection waveforms including a first ejection waveform and a second ejection waveform that is input after the first ejection waveform, and a suppression waveform that is input between the first and second ejection waveforms and suppresses residual vibration generated by the first ejection waveform. The second ejection waveform is input at a timing at which vibration generated by the first ejection waveform and vibration generated by the suppression waveform intensify each other. A speed of a droplet ejected by the second ejection waveform is greater than a speed of a droplet ejected by the first ejection waveform.

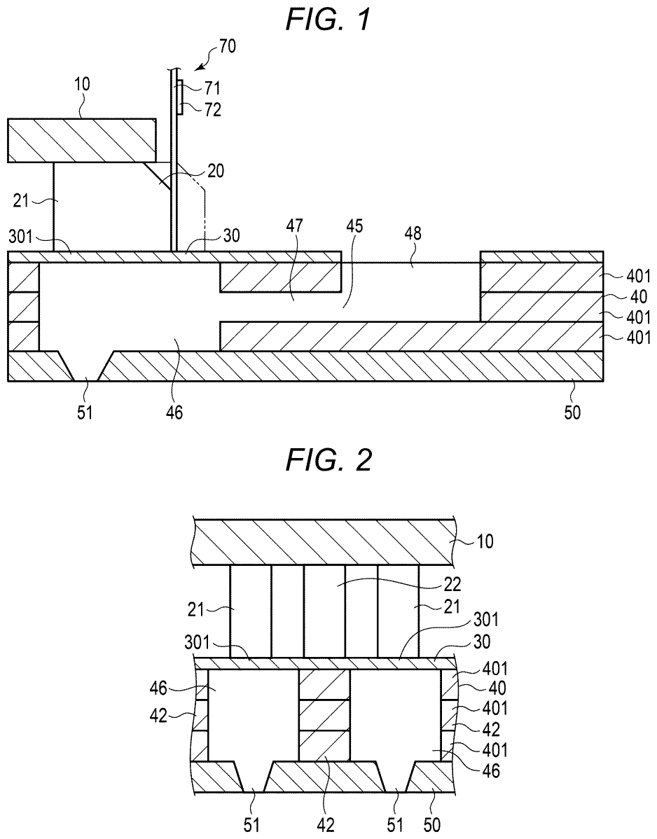

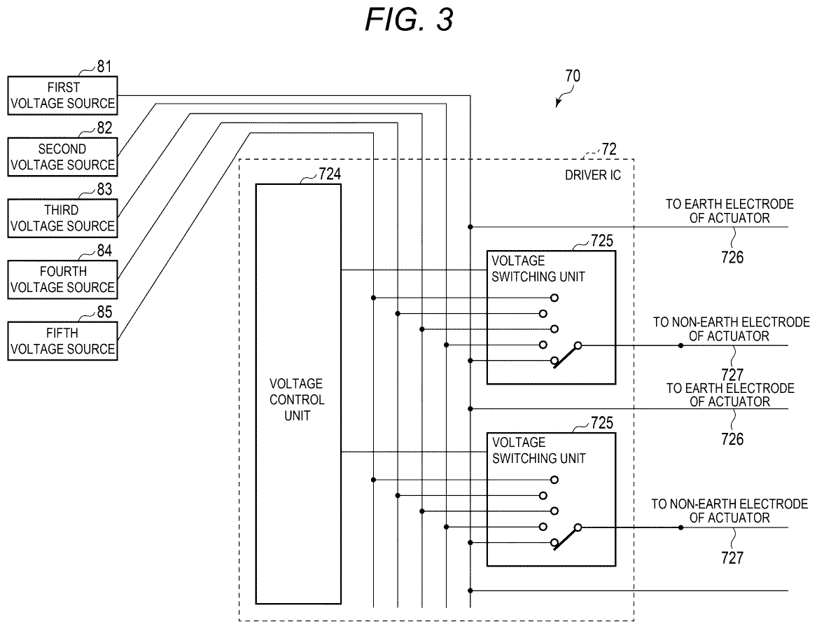

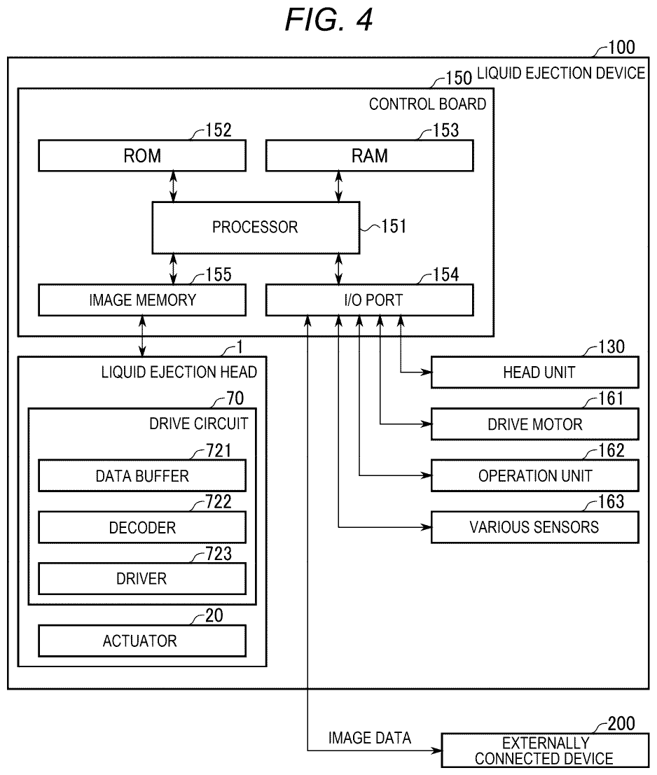

Hereinafter, a configuration of a liquid ejection head 1 according to an embodiment will be described with reference to FIGS. 1 to 4. FIG. 1 is a cross-sectional of the liquid ejection head 1, and FIG. 2 is another cross-sectional view of the liquid ejection head 1. FIG. 3 is a block diagram a drive circuit 70 of the liquid ejection head 1. FIG. 4 is a block diagram of a liquid ejection device 100. In the drawings, configurations are shown enlarged, reduced, or omitted as appropriate for the purpose of description.

The liquid ejection head 1 according to the embodiment is, for example, an inkjet head that ejects ink as a liquid. As shown in FIGS. 1 and 2, the liquid ejection head 1 includes a base 10, an actuator 20, a vibration plate 30, a flow path plate 40, a nozzle plate 50 having a plurality of nozzles 51, and the drive circuit 70.

The base 10 is formed in, for example, a rectangular plate shape. The actuator 20 is bonded to the base 10.

The actuator 20 is, for example, a piezoelectric member including a plurality of piezoelectric pillars 21 and a plurality of non-driven piezoelectric pillars 22 arranged alternately with the plurality of piezoelectric pillars 21. The actuator 20 is formed in a comb shape by arranging the plurality of piezoelectric pillars 21 and the plurality of non-driven piezoelectric pillars 22 in one direction at predetermined intervals. For example, in such an actuator 20, grooves are formed by dicing a laminated piezoelectric member bonded to the base 10 from an end surface opposite to the base 10 side, and a plurality of piezoelectric elements formed in a rectangular columnar shape are formed at predetermined intervals with respect to a single piezoelectric member. Then, the plurality of formed piezoelectric elements are provided with electrodes or the like to constitute the plurality of piezoelectric pillars 21 and the plurality of non-driven piezoelectric pillars 22 which are alternately arranged as piezoelectric elements. That is, one end side (the vibration plate 30 side) of the actuator 20 is divided into a plurality of parts by the plurality of formed grooves, and the other end side (the base 10 side) is connected.

For example, the laminated piezoelectric members constituting the actuator 20 are formed by laminating and sintering sheet-shaped piezoelectric materials. As a specific example, as shown in FIGS. 1 and 2, the piezoelectric pillars 21 and the non-driven piezoelectric pillars 22 are, for example, laminated piezoelectric bodies serving as drive elements. Each of the piezoelectric pillars 21 and the non-driven piezoelectric pillars 22 includes a plurality of laminated piezoelectric layers, a plurality of internal electrodes formed on main surfaces of the piezoelectric layers, and a plurality of external electrodes. For example, the piezoelectric pillars 21 and the non-driven piezoelectric pillars 22 have the same configuration.

The piezoelectric layer is formed of a piezoelectric material such as a lead zirconate titanate (PZT) based material or a lead-free sodium potassium niobate (KNN) based material into a thin plate shape. The plurality of piezoelectric layers are laminated in the thickness direction and bonded by sintering. The lamination direction of the plurality of piezoelectric layers is orthogonal to the arrangement direction of the plurality of piezoelectric pillars 21 and the plurality of non-driven piezoelectric pillars 22.

The internal electrode is a conductive film formed in a predetermined shape from a sinterable conductive material such as silver palladium. The internal electrode is formed on predetermined regions on the main surfaces of the piezoelectric layers. The plurality of internal electrodes are alternately formed to have different poles in the arrangement direction.

The external electrodes are formed on surfaces of the plurality of piezoelectric pillars 21 and the plurality of non-driven piezoelectric pillars 22, and are constituted by collecting end portions of the internal electrodes. The external electrodes are formed of Ni, Cr, Au, or the like by a known method such as plating or sputtering. The plurality of external electrodes are disposed on different side surface portions of the plurality of piezoelectric pillars 21 and the plurality of non-driven piezoelectric pillars 22, respectively, and have different poles. The different external electrodes may be disposed on different regions on the same side surface portions of the plurality of piezoelectric pillars 21 and the plurality of non-driven piezoelectric pillars 22.

For example, the plurality of external electrodes include individual electrodes respectively formed on the plurality of piezoelectric pillars 21 and the plurality of non-driven piezoelectric pillars 22, and common electrodes continuously formed on the plurality of piezoelectric pillars 21 and the plurality of non-driven piezoelectric pillars 22. The plurality of individual electrodes formed on the plurality of piezoelectric pillars 21 and the plurality of non-driven piezoelectric pillars 22 are disposed independently of each other. The common electrode is grounded, for example.

These external electrodes are connected to the drive circuit 70, for example. For example, each of the external electrodes is connected to a control unit 150 serving as a drive unit via a driver 723 described later of the drive circuit 70 via wiring, and is implemented to be driven under the control of a processor 151.

When a voltage is applied to the internal electrode via the external electrodes, the piezoelectric pillars 21 and the non-driven piezoelectric pillars 22 vibrate longitudinally along the lamination direction of the piezoelectric layers. The term “vibrate longitudinally” referred to here is, for example, “vibrate in a thickness direction defined by a piezoelectric constant d33”. For example, as shown in FIG. 2, the plurality of alternating piezoelectric pillars 21 are disposed corresponding to pressure chambers 46 with the vibration plate 30 interposed therebetween, and the remaining non-driven piezoelectric pillars 22 are disposed at positions facing partition wall portions 42 with the vibration plate 30 interposed therebetween.

The piezoelectric pillar 21 vibrates longitudinally by a voltage being applied to displace the vibration plate 30. That is, the piezoelectric pillars 21 deform the pressure chambers 46. The non-driven piezoelectric pillars 22 are disposed at positions facing the partition wall portions 42. No voltage is applied to the non-driven piezoelectric pillars 22. That is, each piezoelectric pillar 21 serves as an actuator that deforms the pressure chamber 46 by being driven, and each non-driven piezoelectric pillar 22 serves as a support pillar. That is, the piezoelectric pillar 21 varies the volume of the pressure chamber 46 by expanding and contracting the pressure chamber 46.

The vibration plate 30 is bonded to one side in the lamination direction of the piezoelectric layers of the plurality of piezoelectric pillars 21 and 22, that is, a surface on the nozzle plate 50 side. The vibration plate 30 is deformed by, for example, the driving of the piezoelectric pillars 21. The vibration plate 30 is bonded to the piezoelectric pillars 21 and the non-driven piezoelectric pillars 22 of the actuator 20.

The vibration plate 30 has, for example, a flat plate shape and is disposed such that the thickness direction is the lamination direction of the piezoelectric layer. The vibration plate 30 has a surface extending in the arrangement direction of the plurality of piezoelectric pillars 21 and the plurality of non-driven piezoelectric pillars 22. The vibration plate 30 is, for example, a metal plate. The vibration plate 30 has a plurality of vibration portions 301 that face the respective pressure chambers 46 and can be displaced individually. The vibration plate 30 is formed by integrally coupling the plurality of vibration portions 301.

For example, the vibration plate 30 is formed in a single flat plate shape, and regions bonded to the piezoelectric pillars 21 are individually displaced. The vibration plate 30 is formed of a SUS plate, for example. In the vibration plate 30, a fold or a step may be formed at a portion adjacent to the vibration portion 301 or between the vibration portions 301 adjacent to each other so that the plurality of vibration portions 301 are easily displaced.

The piezoelectric pillar 21 expands and contracts due to longitudinal vibration, and a portion of the vibration plate 30 facing the piezoelectric pillar 21 is displaced, thereby expanding and contracting the pressure chamber 46 and changing the volume of the pressure chamber 46.

The vibration plate 30 has a main surface on one side bonded to the actuator 20 and a main surface on the other side bonded to the flow path plate 40. The pressure chamber 46 capable of containing an ink is formed between the vibration plate 30 and the flow path plate 40.

One main surface of the vibration plate 30 faces the piezoelectric pillars 21 and 22, and the other main surface faces the pressure chambers 46 and the partition wall portions 42.

The flow path plate 40 is bonded to the vibration plate 30. The flow path plate 40 is disposed between the nozzle plate 50 and the vibration plate 30. The flow path plate 40 has a plurality of partition wall portions 42. The flow path plate 40 forms a predetermined flow path 45. For example, the flow path plate 40 is formed by laminating a plurality of plates 401 each having an opening to form the plurality of partition wall portions 42 and the predetermined flow path 45.

The plurality of partition wall portions 42 are disposed in the arrangement direction of the plurality of piezoelectric pillars 21 and 22 and face the non-driven piezoelectric pillars 22 via the vibration plate 30. The partition wall portions 42 separate the plurality of pressure chambers 46 (to be described later) of the predetermined flow path 45 and a plurality of individual flow paths 47.

The predetermined flow path 45 includes the plurality of pressure chambers 46 separated by the partition wall portions 42 of the flow path plate 40, the plurality of individual flow paths 47 separated by the partition wall portions 42, and a common flow path 48 communicating with the plurality of individual flow paths 47.

The plurality of pressure chambers 46 are arranged in the arrangement direction of the plurality of piezoelectric pillars 21 and the plurality of non-driven piezoelectric pillars 22, and face the plurality of piezoelectric pillars 21 via the vibration plate 30. The plurality of pressure chambers 46 arranged in one direction are separated by the partition wall portions 42. The plurality of partition wall portions 42 disposed between the plurality of pressure chambers 46 face the plurality of non-driven piezoelectric pillars 22 via the vibration plate 30. The plurality of pressure chambers 46 are formed by closing one side of the flow path plate 40 with the vibration plate 30 and closing the other side with the nozzle plate 50 in the lamination direction of the piezoelectric layers. A nozzle 51 formed in the nozzle plate 50 is disposed in each pressure chamber 46.

The plurality of pressure chambers 46 communicate with the common flow path 48 via the individual flow paths 47. Each pressure chamber 46 holds liquid supplied from the common flow path 48 via the individual flow paths 47, and ejects the liquid from the nozzle 51 by being deformed by the vibration of the vibration plate 30 forming a part of the pressure chamber 46. Each individual flow path 47 connects the common flow path 48 and the pressure chamber 46. The individual flow paths 47 are provided in the same number as the pressure chambers 46. A flow path cross-sectional shape of the individual flow path 47 is different from a flow path cross-sectional shape of the pressure chamber 46. The flow path cross-sectional area of the individual flow paths 47 is smaller than a flow path cross-sectional area of the pressure chamber 46. The common flow path 48 is fluidly connected to the plurality of individual flow paths 47 and communicates with the pressure chambers 46 through the individual flow paths 47.

The nozzle plate 50 is formed of a metal, such as SUS or Ni, or a resin material, such as polyimide, for example. The nozzle plate 50 is bonded to the flow path plate 40 and covers the plurality of pressure chambers 46. The nozzle plate 50 has a plurality of nozzles 51 formed at positions facing the plurality of pressure chambers 46 and penetrating in the thickness direction. A nozzle row is formed by the plurality of nozzles 51.

As shown in FIG. 4, the drive circuit 70 includes a data buffer 721, a decoder 722, and the driver 723. The data buffer 721 stores printing data in time series for each of the piezoelectric pillars 21 and 22. The decoder 722 controls the driver 723 based on the printing data stored in the data buffer 721 for each of the piezoelectric pillars 21 and 22. The driver 723 outputs drive signals for operating the piezoelectric pillars 21 and 22 under the control of the decoder 722. The drive signal is a voltage applied to each of the piezoelectric pillars 21 and 22.

As a specific example, as shown in FIG. 1, the drive circuit 70 includes a wiring film 71 having one end connected to the external electrodes, a driver IC 72 mounted on the wiring film 71, and a printed wiring board mounted on the other end of the wiring film 71. For example, the driver IC 72 includes the data buffer 721, the decoder 722, and the driver 723. The driver IC 72 may include a part of the data buffer 721, the decoder 722, and the driver 723, and the printed wiring board or the like may include the remaining part.

The drive circuit 70 applies a drive voltage to the external electrode by the driver IC 72 to drive the piezoelectric pillars 21, changes the volume of the pressure chambers 46, and causes droplets to be ejected from the nozzles 51.

The wiring film 71 is connected to the plurality of individual electrodes and the common electrodes. For example, the wiring film 71 is an anisotropic conductive film (ACF) fixed to connection portions with the external electrode by thermo-compression bonding or the like. The wiring film 71 is, for example, a chip on film (COF) on which the driver IC 72 is mounted.

The driver IC 72 is connected to the external electrode via the wiring film 71. Instead of the wiring film 71, the driver IC 72 may be connected to the external electrode by other methods such as an anisotropic conductive paste (ACP), a non-conductive film (NCF), and a non-conductive paste (NCP).

The driver IC 72 applies a control signal and a drive signal to the respective piezoelectric pillars 21 and 22 to operate the piezoelectric pillars 21. The driver IC 72 generates, according to an image signal input from the control unit 150 of the liquid ejection device 100, a control signal for controlling the timing of ejecting the ink and selecting the piezoelectric pillar 21 that ejects the ink. The driver IC 72 generates a voltage to be applied to the piezoelectric pillar 21, that is, a drive signal (an electric signal), according to the control signal. When the driver IC 72 applies the drive signal to the piezoelectric pillar 21, the piezoelectric pillar 21 displaces the vibration plate 30, thereby driving the pressure chamber 46 to change the volume to expand and contract. Accordingly, the ink filled in the pressure chamber 46 undergoes pressure vibration. Due to the pressure vibration, the ink is ejected from the nozzle 51 provided in the pressure chamber 46. The liquid ejection head 1 may be implemented to achieve gradation expression by changing the amount of ink droplets that land on one pixel. The liquid ejection head 1 may be implemented to change the amount of ink droplets that land on one pixel by changing the number of times of ink ejection. In this manner, the driver IC 72 is an example of an application unit that applies a drive signal to the piezoelectric pillar 21.

Next, an example of the drive circuit 70 will be described with reference to FIG. 3. The drive circuit 70 includes, for example, a voltage control unit 724 and the same number of voltage switching units 725 as the pressure chambers 46 in the driver IC 72. However, in FIG. 3, two voltage switching units 725 are shown, and illustration of other voltage switching units 725 is omitted.

The drive circuit 70 is connected to a first voltage source 81, a second voltage source 82, a third voltage source 83, a fourth voltage source 84, and a fifth voltage source 85. The drive circuit 70 applies a voltage supplied from the first voltage source 81 to each wiring electrode 726. The drive circuit 70 selectively applies, to wiring electrodes 727, the voltages supplied from the first voltage source 81, the second voltage source 82, the third voltage source 83, the fourth voltage source 84, and the fifth voltage source 85. Here, when the actuator 20 is a laminated PZT, since it tends to deteriorate when a bipolar voltage is applied, the voltages supplied by the first voltage source 81, the second voltage source 82, the third voltage source 83, the fourth voltage source 84, and the fifth voltage source 85 are preferably set to a ground voltage and either positive or negative with respect to the ground voltage.

The output voltage of the first voltage source 81 is, for example, a reference voltage (or a reference potential), and its voltage value is V0 (V0>0 [V] or V0<0 [V]). A voltage value indicated by the output voltage of the second voltage source 82 is V1. The voltage value V1 is a voltage higher than V0. A voltage value indicated by the output voltage of the third voltage source 83 is, for example, V2. For example, the voltage value V2 is a voltage higher than V0 and lower than V1. A voltage value indicated by the output voltage of the fourth voltage source 84 is V3. The voltage value V3 is a voltage lower than V0. A voltage value indicated by the output voltage of the fifth voltage source 85 is, for example, V4. For example, the voltage value V4 is a voltage lower than V0 and higher than V3. The lowest voltage (e.g., V3 or the fourth voltage source 84) may serve as the ground level depending on the circuit configuration.

The wiring electrode 726 is connected to a common electrode as an earth electrode of the actuator 20. Each of the plurality of wiring electrodes 727 is connected to an individual electrode as a non-earth electrode of the actuator 20.

The voltage control unit 724 is connected to each of the plurality of voltage switching units 725. The voltage control unit 724 outputs, to each voltage switching unit 725, a command indicating which voltage source among the first voltage source 81, the second voltage source 82, and the third voltage source 83 is selected. For example, the voltage control unit 724 receives an image signal from the control unit 150 and determines a switching timing of the voltage source in each voltage switching unit 725. Further, the voltage control unit 724 outputs the command to select any one of the first voltage source 81, the second voltage source 82, and the third voltage source 83 to the voltage switching unit 725 at the determined switching timing. The voltage switching unit 725 switches the voltage source connected to the wiring electrode 727 according to the command from the voltage control unit 724.

The voltage switching unit 725 includes, for example, a semiconductor switch. The voltage switching unit 725 connects any one of the first voltage source 81, the second voltage source 82, the third voltage source 83, the fourth voltage source 84, and the fifth voltage source 85 to the wiring electrode 727 under the control of the voltage control unit 724. Therefore, the internal electrodes of different poles of the piezoelectric pillar 21 are connected to the wiring electrode 726 and the wiring electrode 727 via the external electrodes (the common electrode and the individual electrode).

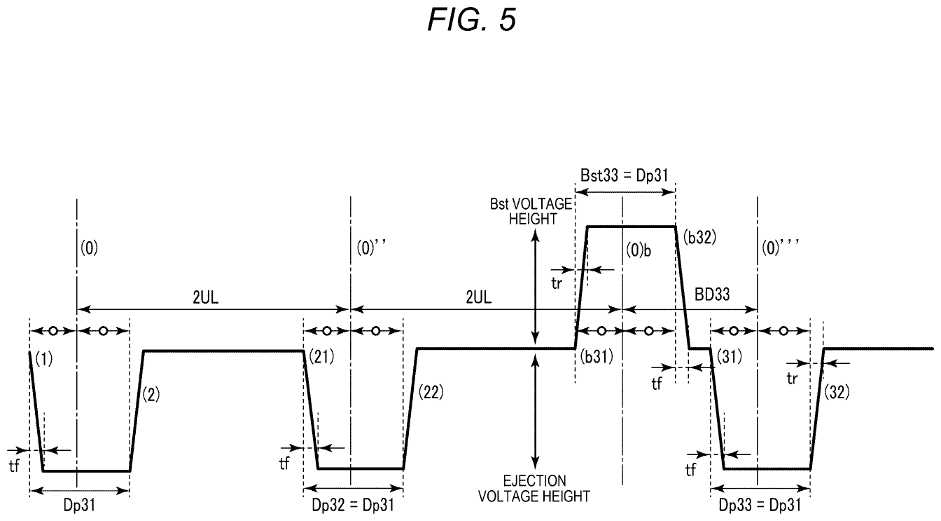

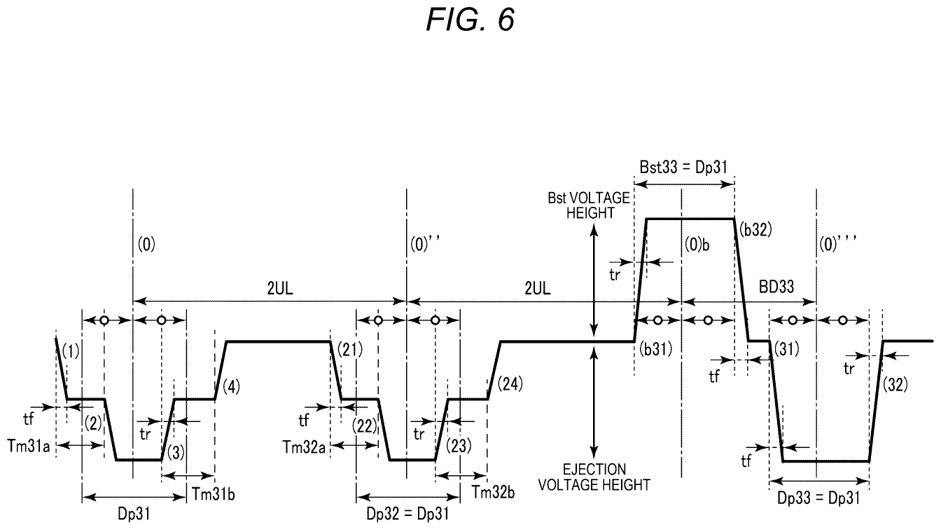

Such a drive circuit 70 switches connection wirings between the voltage sources 81 to 85 and the actuator 20 using the switching circuit including the voltage control unit 724 and the plurality of voltage switching units 725, and inputs drive waveforms having at least five types of potential differences as drive signals between the electrodes of the actuator 20. Here, the drive waveform includes an ejection waveform for ejecting droplets by driving the actuator 20. In the embodiment, a potential difference other than the largest potential difference and the smallest potential difference is referred to as an intermediate potential difference. As an example, FIGS. 6, 8, and 10 to 12 show examples of drive waveforms including an intermediate potential difference. In the examples of the drive waveforms of FIGS. 5, 7, and 9 described later, since the drive waveforms do not include the intermediate potential difference and have three types of potential differences, three voltage sources are sufficient. Therefore, in order to input such a drive waveform between the electrodes of the actuator 20, for example, the drive circuit 70 may be configured such that the first voltage source 81, the second voltage source 82, and the fourth voltage source 84 are connected to the drive circuit 70.

The printed wiring board is a printed wiring assembly (PWA) on which various electronic components and connectors are mounted. The printed wiring board is connected to the control unit 150 of the liquid ejection device 100.

Next, an example of the liquid ejection device 100 including the liquid ejection head 1 will be described with reference to FIG. 4. The liquid ejection device 100 is, for example, an inkjet recording device. The liquid ejection device 100 is a liquid ejection device that performs an image forming process on a sheet by ejecting liquid such as ink while transporting the sheet as a printing medium, which is an ejection target from a medium supply unit. The liquid ejection device 100 includes, for example, a head unit 130, a control unit 150, a drive motor 161 that drives a transport device that transports sheets, an operation unit 162 that inputs commands from the outside, and various sensors 163.

The head unit 130 includes the liquid ejection head 1, ink tanks as liquid tanks mounted on the liquid ejection head 1, a connection flow path connecting the liquid ejection head 1 and the ink tanks, and a supply pump that supplies ink to the liquid ejection head 1.

In the embodiment, a plurality of head units 130 are provided. Each head unit 130 uses, for example, ink of a different color. In the head unit 130, a negative pressure control device such as a pump is connected to the ink tank. The head unit 130 controls the negative pressure inside the ink tank using a negative pressure control device according to the head value between the liquid ejection head 1 and the ink tank, thereby forming the ink supplied to each nozzle 51 of the liquid ejection head 1 into a meniscus of a predetermined shape. The supply pump is a liquid feed pump implemented by, for example, a piezoelectric pump, and is controlled by the control unit 150.

The control unit 150 is, for example, a control board. The control unit 150 includes a processor 151, a read only memory (ROM) 152, a random access memory (RAM) 153, an I/O port 154 which is an input and output port, and an image memory 155.

The processor 151 is a processing circuit such as a central processing unit (CPU) which is a controller. The processor 151 controls the head unit 130, the drive motor 161, the operation unit 162, various sensors 163, and the like provided in the liquid ejection device 100 through the I/O port 154. The processor 151 transmits printing data stored in the image memory 155 to the drive circuit 70 in a drawing order.

The ROM 152 stores various programs. The RAM 153 temporarily stores various types of variable data, image data, and the like. The ROM 152 and the RAM 153 are examples of storage media, and other storage media may be used as long as they can store various programs, data, and the like. The I/O port 154 is an interface unit that inputs data from the outside, such as from an externally connected device 200, and outputs data to the outside. The printing data from the externally connected device 200 is transmitted to the control unit 150 through the I/O port 154, and is stored in the image memory 155.

Hereinafter, characteristics of the liquid ejection head 1 according to the embodiment and a drive waveform (an ejection waveform of a drive signal) of the liquid ejection head 1 will be described. The drive waveform of the liquid ejection head 1 according to the embodiment is formed by a rectangular waveform including an expansion potential difference for expanding the volume of the pressure chamber 46 and a contraction potential difference for contracting the volume of the pressure chamber 46, and/or a stepped waveform including an expansion potential difference, a contraction potential difference, and one or more intermediate potential differences provided between the potential differences.

FIG. 5 is a diagram illustrating an example of a drive waveform (3-drop waveform) including rectangular ejection waveforms for performing pull-ejection to eject three droplets and one rectangular boost waveform. FIG. 6 is a diagram illustrating an example of a drive waveform (3-drop waveform) including stepped ejection waveforms for performing pull-ejection to eject three droplets and one rectangular boost waveform.

Here, a rectangular waveform is a waveform having rising and falling edges with a single potential difference of one with respect to the reference potential. Further, a stepped waveform is a waveform that has rising and falling edges with two potential differences on the same polarity side with respect to the reference potential, and that holds a predetermined time (intermediate voltage time) at an intermediate voltage between the two potential differences. The ejection waveform and the boost waveform have different polarities with respect to the reference potential. The boost waveform is a waveform that cancels out residual vibrations of the main acoustic vibration frequency generated in the pressure chamber 46 by the ejection waveform input before the boost waveform is input, and also increases the amplitude of the pressure vibration (ejection force of the droplet) in the pressure chamber 46 caused by the ejection waveform input after the boost waveform is input.

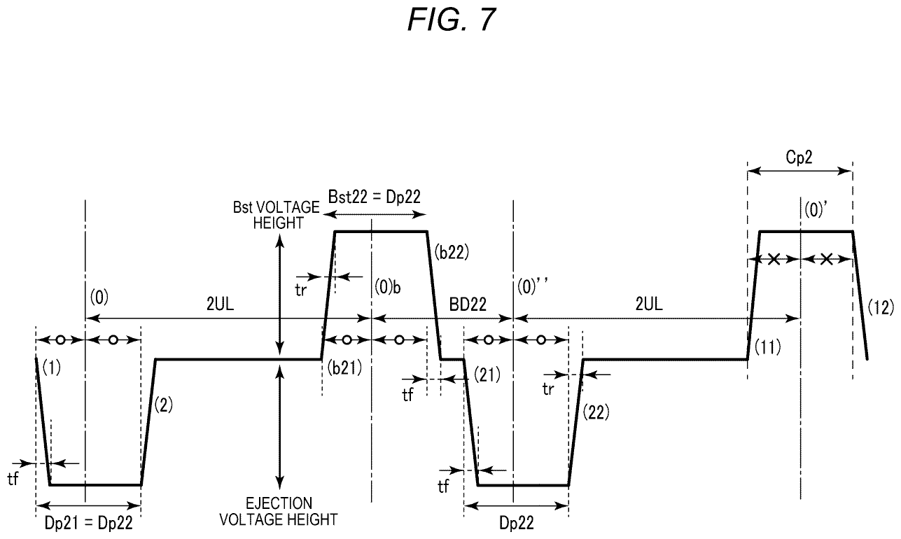

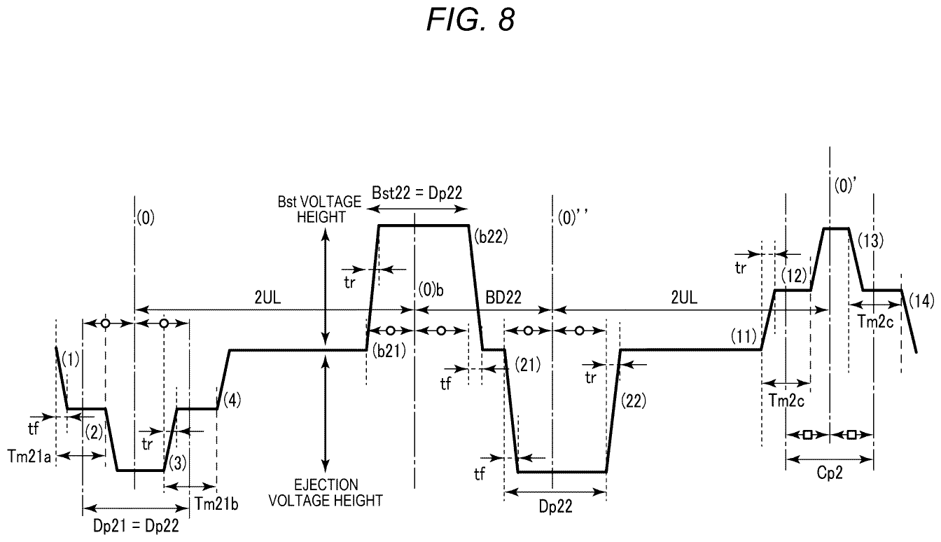

FIG. 7 is a diagram illustrating an example of a drive waveform (2-drop waveform) including rectangular ejection waveforms for ejecting two droplets, one rectangular boost waveform, and one rectangular cancellation waveform. Here, the cancellation waveform is a waveform that cancels out the residual vibration of the main acoustic vibration frequency generated in the pressure chamber 46 by the ejection waveform that ejects droplets. FIG. 8 is a diagram illustrating an example of a drive waveform (2-drop waveform) including stepped and rectangular ejection waveforms for ejecting two droplets, one rectangular boost waveform, and one stepped cancellation waveform.

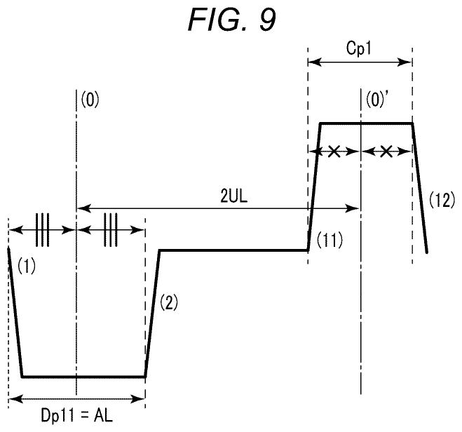

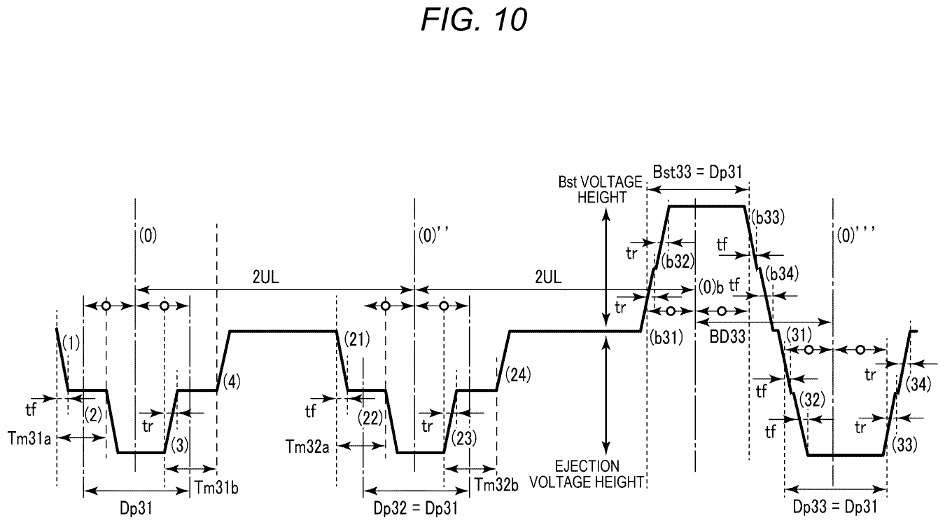

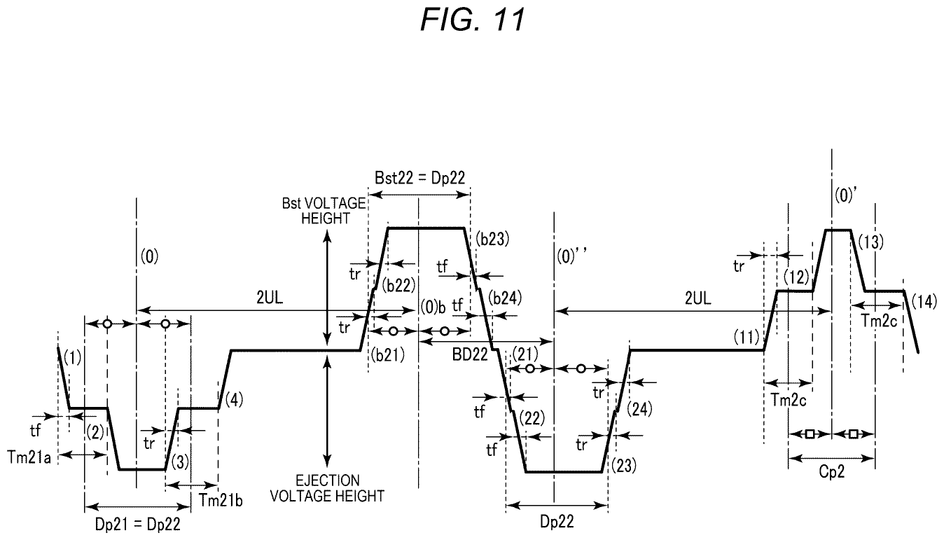

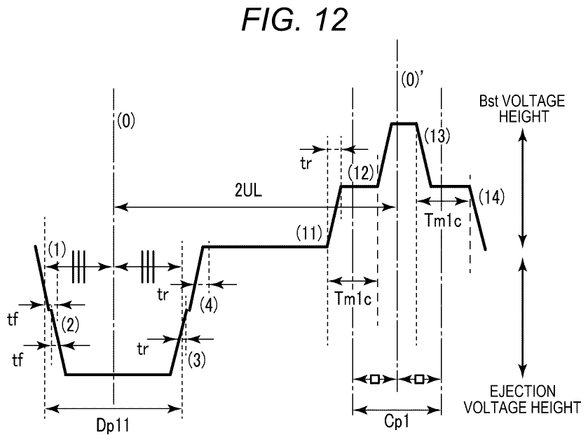

FIG. 9 is a diagram illustrating an example of a drive waveform (1-drop waveform) including a rectangular ejection waveform for ejecting one droplet and one rectangular cancellation waveform. FIG. 10 is a diagram illustrating an example of a drive waveform (3-drop waveform) including stepped ejection waveforms for ejecting three droplets and one stepped boost waveform, and FIG. 11 is a diagram illustrating an example of a drive waveform (2-drop waveform) including stepped ejection waveforms for ejecting two droplets, one stepped boost waveform, and one stepped cancellation waveform. FIG. 12 is a diagram illustrating an example of a drive waveform (1-drop waveform) including a stepped ejection waveform for ejecting one droplet and one stepped cancellation waveform. In addition, in the examples of the drive waveforms in FIGS. 5, 6, and 10, the cancellation waveform is omitted, but the drive waveform may include the cancellation waveform. A waveform width Cp of the cancellation waveform is shorter than AL. The waveform width Cp of the cancellation waveform is different from a waveform width Dp of the ejection waveform and a waveform width Bst of the boost waveform.

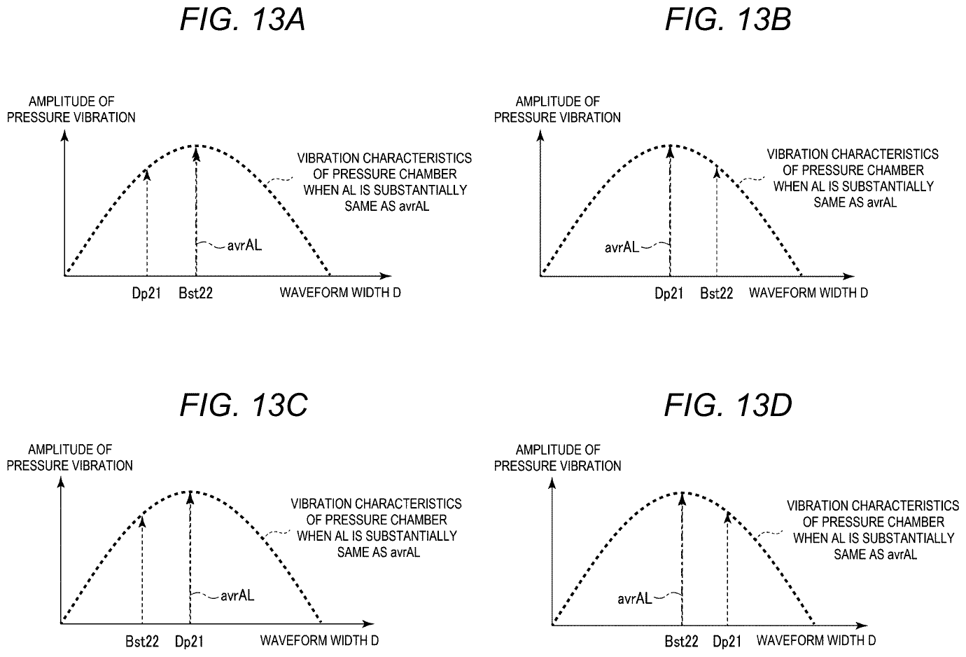

FIG. 13A to FIG. 16D are diagrams schematically showing the amplitude characteristics of the pressure vibration of the pressure chamber 46 with broken lines, with the horizontal axis representing the waveform width and the vertical axis representing the amplitude of the pressure vibration relative to the waveform width when there is no residual vibration. FIG. 13A to FIG. 16D schematically show a relationship between the vibration characteristics of the pressure chamber 46 with respect to the waveform width and the amplitude of the pressure vibration that is applied to the pressure chamber 46 by the ejection waveform with the waveform width Dp and the boost waveform with the waveform width Bst. In FIG. 13A to FIG. 16D and in the following description, avrAL (average AL) is an average value of AL of the plurality of pressure chambers 46 to which the same drive waveform is input. minAL is a minimum value of AL of the plurality of pressure chambers 46 to which the same drive waveform is input. maxAL is a maximum value of AL of the plurality of pressure chambers 46 to which the same drive waveform is input.

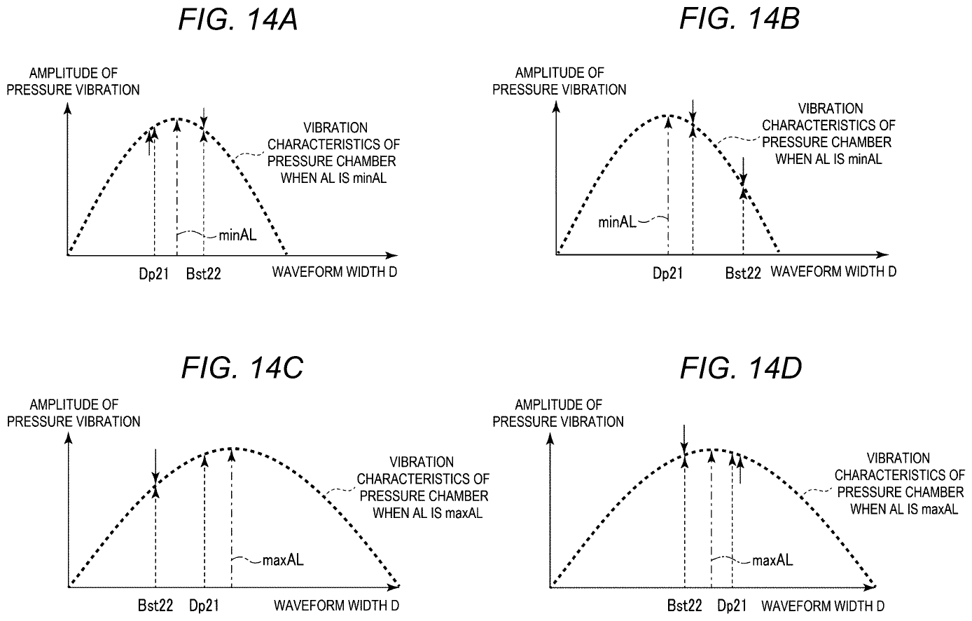

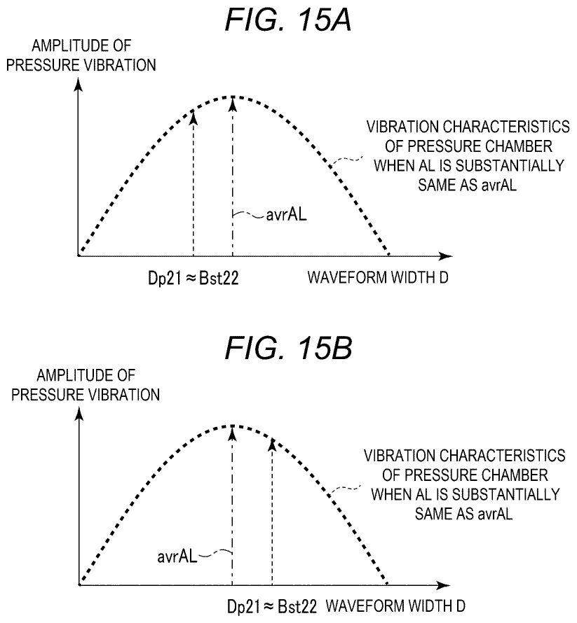

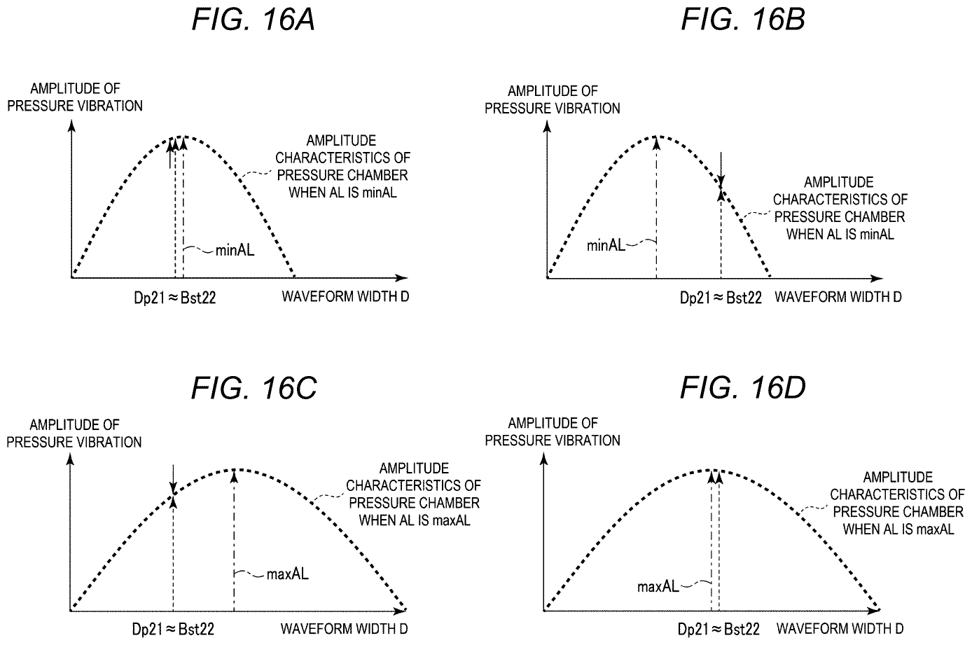

FIGS. 13A to 13D illustrate vibration characteristics of the pressure chamber 46 when a half period of the main acoustic vibration frequency of the pressure chamber 46 AL=avrAL, and also illustrate examples in which the waveform width Dp of the main acoustic vibration ejection waveform and the waveform width Bst of the boost waveform are different (Dp≠Bst). FIGS. 14A to 14D illustrate vibration characteristics of the pressure chamber 46 when AL=minAL and AL=maxAL, and also illustrate examples in which Dp and Bst are different (Dp≠Bst) and Dp is larger in amplitude than Bst. FIGS. 15A and 15B illustrate vibration characteristics of the pressure chamber 46 when AL=avrAL, and also illustrate examples in which Dp and Bst are substantially the same (Dp≈Bst). FIGS. 16A to 16D illustrate vibration characteristics of the pressure chamber 46 when AL=minAL and AL=maxAL, and also illustrate examples in which Dp and Bst are substantially the same (Dp≈Bst).

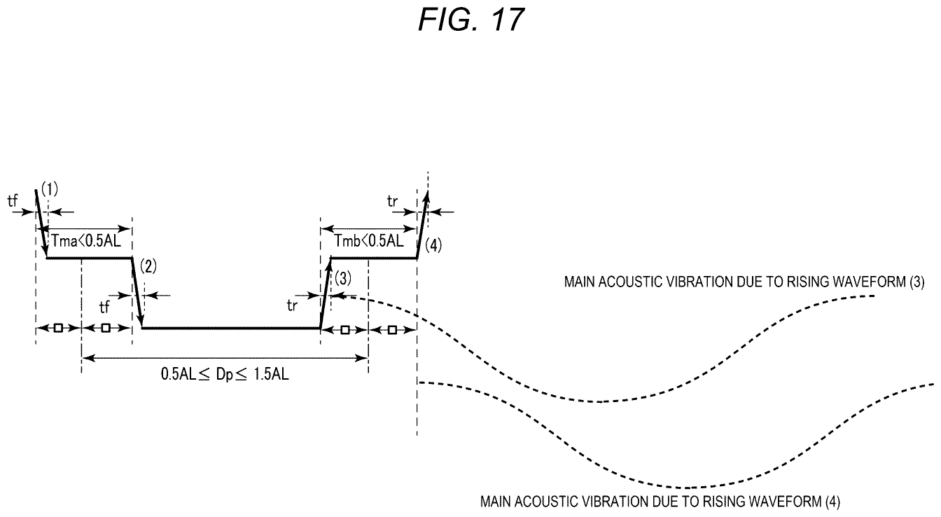

FIG. 17 is a diagram illustrating an example of a relationship between a stepped ejection waveform of the drive waveform and the main acoustic vibration caused by the rising waveforms (3) and (4).

In addition, regarding the drive waveforms of the present embodiment, examples will be described in which a 1-drop waveform for ejecting one droplet, a 2-drop waveform for ejecting two droplets, and a 3-drop waveform for ejecting three droplets are selectively used to achieve graduation expression of ink density on the medium. The 1-drop waveform is a simple pull-ejection waveform as shown in FIG. 9. The 1-drop waveform may have a waveform shape different from that in FIG. 9.

Next, in one example of the ejection waveform of the present embodiment, the waveform width of a stepped waveform having an intermediate voltage time Tma or Tmb as illustrated in FIG. 17 will be described below. First, a composite wave of two main acoustic vibrations, the rising waveforms (3) and (4) will be considered. In the following description, the half period of the main acoustic vibration frequency of the pressure chamber 46 is denoted as AL, and the input time of a falling waveform and a rising waveform is denoted as tin. First, at the timing of tin3, the rising waveform (3) is input, and a positive pressure with a phase of zero and an amplitude of A3 is input to the pressure chamber 46. The pressure vibration due to the rising waveform (3) advances in phase by Tmb*(π/AL) at a time point when Tmb elapses. Further, the amplitude of the pressure vibration after Tmb is set to A3′. At a timing of tin4 after the lapse of Tmb from tin3, the rising waveform (4) is input, and a positive pressure with a phase of zero and an amplitude of A4 is input to the pressure chamber 46. The composite wave of the rising waveform (3) (amplitude A3′ and phase Tmb*(π/AL)) and the rising waveform (4) (amplitude A4 and phase zero) at time point tin4 can be calculated using the formula for the composition of simple harmonic motion. Here, it is assumed that the amplitude of the composite wave of the rising waveforms (3) and (4) at the time point tin4 is A (3+4), and the phase of the composite wave is φ(3+4). The pressure vibration of the rising waveform (3) at the time point tin4 is schematically expressed as A3′ cos((tin4−tin3)*(π/AL)), and the pressure vibration of (4) at the time point tin4 is schematically expressed as A4 cos((tin4−tin4)*(π/AL))=A4 cos θ=A4.

Therefore, φ(3+4) at the time point tin4 is φ(3+4)=arctan ((A3′ sin((tin4−tin3) * (w/AL)+A4 sin 0)/(A3′ cos((tin4−tin3)*(π/AL)+A4 cos θ)). When the phase φ(3+4) of the main acoustic vibration is converted into time, φ(3+4)*AL/π is obtained. Here, an observation time point of the composite wave of the rising waveforms (3) and (4) is defined as t0(3+4), and the composite wave of the rising waveforms (3) and (4) before tin4 is assumed.

The observation time point t0(3+4) at which the phase of the composite wave of the assumed rising waveforms (3) and (4) becomes zero is tin4−φ(3+4) * AL/π, which is the time point going back from tin4 by the phase φ(3+4).

Next, a composite wave of two main acoustic vibrations, the falling waveforms (1) and (2) will be considered. At the timing of tin1, the falling waveform (1) is input, and pressure vibration with a phase of −π and an amplitude of A1 is input to the pressure chamber 46. It should be noted that, since the falling waveform (1) generates a negative pressure in the pressure chamber 46, the phase here is set to −π. The pressure vibration due to the falling waveform (1) advances in phase by Tma*(π/AL) at a time point when Tma elapses. Further, the amplitude of the pressure vibration after Tma is set to A1′.

The falling waveforms (1) and (2) can be considered as composite waves, similar to the rising waveforms (3) and (4), except that negative pressure is input to the pressure chamber 46 at the time point of input.

Here, it is assumed that the amplitude of the composite wave of the falling waveforms (1) and (2) at the time point tin2 is A (1+2), and the phase of the composite wave is φ(1+2). The pressure vibration of the falling waveform (1) at the time point tin2 is schematically expressed as A1′ cos((tin2−tin1)*(π/AL)−π). Further, the pressure vibration of the falling waveform (2) at the time point tin2 is schematically expressed as A2 cos((tin2−tin2)*(π/AL)−π)=A2 cos (−π)=−A2.

Therefore, φ(1+2) at the time point tin2 is φ(1+2)=arctan ((A1′ sin((tin2−tin1)*(π/AL)−1)+A2 sin (−1)/(A1′ cos((tin2−tin1)*(π/AL)−T)+A2 cos (−π))). An observation time point of the composite wave of the falling waveforms (1) and (2) is defined as t0(1+2), and the composite wave of the falling waveforms (1) and (2) before tin2 is assumed.

The observation time point t0(1+2) at which the phase of the composite wave of the assumed falling waveforms (1) and (2) becomes −π is tin2−φ(1+2)*AL/π, which is the time point going back from tin2 by the phase φ(1+2) of the composite wave.

When rising waveforms or falling waveforms with the same phase of the main acoustic vibration generated at the time of input are input continuously, if a time interval between the first and last of the continuous inputs is shorter than AL, there is only one observation time point to within the time interval at which the phase of the composite wave of the main acoustic vibration generated by the consecutive inputs becomes a multiple of π (for example, −π, zero, +π). Since Tma and Tmb are shorter than 0.5AL, there is only one observation time point to at which the phase of the composite wave of the main acoustic vibration generated when rising waveforms or falling waveforms are input continuously becomes a multiple of π (for example, −π, zero, +π).

The waveform widths of the ejection waveform of this embodiment and the boost (Bst) waveform described below are from a time point at which the phase becomes a multiple of π in the first input main acoustic vibration or a composite wave of successively input main acoustic vibrations whose phase at the time of input is the same as that of the first vibration, to a time point at which the phase becomes a multiple of π in the next input main acoustic vibration whose phase is different from that of the first vibration, or a composite wave of successively input main acoustic vibrations whose phase at the time of input is different from that of the first vibration.

Specifically, the waveform width of the ejection waveform having the intermediate voltage time Tma or Tmb as illustrated in FIG. 17 is Dp, which is a time interval between the observation time point t0(1+2) at which the phase of the composite wave of the falling waveforms (1) and (2) assumed as described above becomes −π and the observation time point t0(3+4) at which the phase of the composite wave of the rising waveforms (3) and (4) becomes zero.

The waveform width of the Bst waveform in the 3-drop waveform as illustrated in FIG. 10 is Bst33, which is a time interval between the observation time point t0(b31+b32) at which the phase of the composite wave of the rising waveforms (b31) and (b32) becomes zero, and the observation time point t0(b33+b34) at which the phase of the composite wave of the falling waveforms (b33) and (b34) becomes −π.

In FIG. 17, if the amplitude is A3′=A4 at the time point tin4, the observation time point at which the phase of the composite wave of the assumed rising waveforms (3) and (4) becomes zero is the midpoint between tin3 and tin4. Similarly, for the falling waveforms (1) and (2), if the amplitude is A1′=A2 at the time point tin2, the observation time point at which the phase of the composite wave of the assumed falling waveforms (1) and (2) becomes-x is the midpoint between tin1 and tin2. For example, when the voltage heights of the falling waveforms (1) and (2) are the same and the flow path resistance of the pressure chamber or the like is small, or when the time interval between the falling waveforms (1) and (2) is short compared to the period of the main acoustic vibration, the amplitude can be considered as A1′=A2. Similarly, when the voltage heights of the rising waveforms (3) and (4) are the same and the flow path resistance of the pressure chamber or the like is small, or when the time interval between the rising waveforms (3) and (4) is short compared to the period of the main acoustic vibration, the amplitude can be considered as A3′=A4.

In addition, when the voltage heights of the rising waveforms (3) and (4) are the same and the flow path resistance of the pressure chamber or the like is large, the amplitude A3′<A4 at the time point tin4, and the observation time point at which the phase of the composite wave of the assumed rising waveforms (3) and (4) becomes zero moves to the tin4 side from the midpoint between tin3 and tin4. Similarly, when the voltage heights of the falling waveforms (1) and (2) are the same and the flow path resistance of the pressure chamber or the like is large, the amplitude A1′≈A2 at the time point tin2, and the observation time point at which the phase of the composite wave of the assumed falling waveforms (1) and (2) becomes −π moves to the tin2 side from the midpoint between tin1 and tin2.

Therefore, the time interval between the observation time point t0(1+2) at which the phase of the composite wave of the assumed falling waveforms (1) and (2) is −π and the observation time point t0(3+4) at which the phase of the composite wave of the assumed rising waveforms (3) and (4) is zero can be considered to be equivalent to the time interval from the midpoint between tin1 and tin2 to the midpoint between tin3 and tin4.

The shorter the intermediate voltage times Tma and Tmb are, the larger the amplitude of the composite wave described above becomes. When Tmb is zero, it can be considered equivalent to inputting a single step waveform with a rise time tr having a voltage height equal to the sum of the voltage heights of the rising waveforms (3) and (4). Similarly, when Tma is zero, it can be considered equivalent to inputting a single step waveform with a fall time tf having a voltage height equal to the sum of the voltage heights of the falling waveforms (1) and (2).

For example, when the time difference between the rising waveforms (b31) and (b32) in FIG. 10 is zero, the time difference between the falling waveforms (b33) and (b34) is zero, the time difference between the falling waveforms (31) and (32) is zero, and the time difference between the rising waveforms (33) and (34) is zero, the waveform shape can be considered as shown in FIG. 6.

Similarly, when the time difference between the rising waveforms (b21) and (b22) in FIG. 11 is zero, the time difference between the falling waveforms (b23) and (b24) is zero, the time difference between the falling waveforms (21) and (22) is zero, and the time difference between the rising waveforms (23) and (24) is zero, the waveform shape can be considered as shown in FIG. 8.

Further, in order to improve printing quality, when a plurality of drops are ejected continuously, it is desirable that the continuously ejected droplets combine. It is also desirable that the speeds of the droplets ejected by the 1-drop waveform, the 2-drop waveform, and the 3-drop waveform, or the speed after they are combined, are substantially the same.

When driving the liquid ejection head 1 at a high frequency to increase printing speed, since the 3-drop waveform typically has a longer waveform length than the 2-drop waveform, constraints on adjusting the speed of each droplet are typically stricter for the 3-drop waveform. Therefore, the procedure for adjusting the waveform for a 3-drop waveform will be described first, and then the procedure for adjusting the waveform for a 2-drop waveform will be described.

As illustrated in FIGS. 5, 6, and 10, the 3-drop waveform is a waveform in which two ejection waveforms are input first. First, the 3-drop waveform in FIG. 5 ejects the first drop with an ejection waveform having a width of Dp31, and ejects the second drop with an ejection waveform having a width of Dp32. At this time, Dp31=Dp32, and the center distance between the ejection waveform of Dp31 and the ejection waveform of Dp32 is 2UL=2AL. The half periods AL of the main acoustic vibration frequency of the plurality of pressure chambers 46 are not the same due to manufacturing variations. Here, the maximum value of the half periods AL of the main acoustic vibration frequency of the plurality of pressure chambers 46 is defined as maxAL, and the minimum value is defined as minAL. In this case, the value when 1.5AL is the largest in the plurality of pressure chambers 46 is 1.5maxAL, and the value when 2.5AL is the smallest is 2.5minAL. Therefore, 2UL, where 1.5AL≤1.5maxAL<2UL<2.5minAL≤2.5AL, may be set as a time difference (center distance) between the center (0) and the center (0)″ of the waveform.

The interval 2UL between the plurality of continuous ejection waveforms input before a waveform (boost waveform) having a width of Bst33 input after the ejection waveform for the second drop coincides with the period in which the residual vibration of the liquid in the pressure chamber 46 generated by the ejection waveform for the first drop that is input first and the vibration of the liquid in the pressure chamber 46 generated by the ejection waveform for the second drop that is input next are intensified. The center of a waveform is the center of the waveform width (time) from the input of a rising or falling waveform to the input of a rising or falling waveform in each waveform, such as an ejection waveform or a boost waveform, and the center distance of a waveform is the time between the centers of adjacent waveforms.

The waveform (boost waveform) having a width of Bst33 input after the ejection waveform for the second drop cancels out the residual vibration generated in the pressure chamber 46 by the ejection waveform prior to the input of the boost waveform. Here, the boost waveform has a polarity different from that of the ejection waveform with respect to the reference potential. For example, Dp31, Dp32, and Dp33 cause expansion and contraction by a voltage lower than the reference potential, and Bst33 causes expansion and contraction by a voltage higher than the reference potential. Accordingly, the disturbance of the meniscus shape due to the residual vibration generated by the ejection waveform for the first drop and the ejection waveform for the second drop is suppressed, thereby preventing entrainment of air bubbles. Further, the ejection waveform having a width of Dp33 is input immediately after the waveform having a width of Bst33, and the third drop is ejected. Here, Dp33=Dp31.

In order to cancel out the residual vibration generated by the ejection waveform having a width of Dp32 using the waveform having a width of Bst33, the time interval 2UL between the centers (0)″ and (0)b of the waveforms in FIG. 5 is preferably (k−1/6)2AL to (k+1/6)2AL, and more preferably k*2AL. Further, if AL varies from minAL to maxAL, the time interval between the centers (0)″ and (0)b is preferably (k−1/6)2*maxAL to (k+1/6)2*minAL. Note that k is a natural number.

Further, in order to increase the ejection force (that is, the amplitude of the pressure vibration in the pressure chamber 46 due to the ejection waveform) of the ejection waveform having a width of Dp33 using the waveform having a width of Bst33, the time interval between (0)b and (0)′″ in FIG. 5 is preferably (k/2−1/4)2AL to (k/2+1/4)2AL, and more preferably k*AL. Further, if AL varies from minAL to maxAL, the time interval between (0)b and (0)″ is preferably (k/2−1/4)2*maxAL to (k/2+1/4)2*minAL. Note that k is an odd number of 1 or more. In addition, in order to increase the ejection force of the ejection waveform having a width of Dp33 using the waveform having a width of Bst33, the time interval between (0)b and (0)′″ in FIG. 5 is preferably short, and k=1 is more preferable.

The 2-drop waveform in FIG. 7 first ejects the first drop with an ejection waveform having a width of Dp21, and then cancels out the residual vibration generated in the pressure chamber 46 due to ejection prior to the input of the waveform having a width of Bst22 using the waveform (boost waveform) having a width of Bst22. As a result, disturbance of the meniscus shape is suppressed, thereby preventing entrainment of air bubbles. Further, the ejection waveform having a width of Dp22 is input immediately after the waveform having a width of Bst22, and the second drop is ejected.

In order to cancel out the residual vibration generated by the ejection waveform having a width of Dp21 using the waveform having a width of Bst22, the time interval between (0) and (0)b in FIG. 7 is preferably (k−1/6)2AL to (k+1/6)2AL, and more preferably k*2AL. Further, if AL varies from minAL to maxAL, the time interval between (0) and (0)b is preferably (k−1/6)2*maxAL to (k+1/6)2*minAL. Note that k is a natural number.

Further, in order to increase the ejection force of the ejection waveform having a width of Dp22 using the waveform having a width of Bst22, the time interval between (0)b and (0)″ in FIG. 7 is preferably (k/2−1/4)2AL to (k/2+1/4)2AL, and more preferably k*AL. Further, if AL varies from minAL to maxAL, the time interval between (0)b and (0)″ is preferably (k/2−1/4)2*maxAL to (k/2+1/4)2*minAL. Note that k is an odd number of 1 or more. In addition, in order to increase the ejection force of the ejection waveform having a width of Dp22 using the waveform having a width of Bst22, the time interval between (0)b and (0)″ in FIG. 7 is preferably short, and k=1 is more preferable.

Next, a case where the ejection waveform width Dp21 for the first drop and the waveform width of the Bst width are different in the 2-drop waveform will be considered. FIGS. 13A to 16D schematically illustrate the vibration characteristics of the pressure chamber with respect to the waveform width, and the relationship between the waveform widths of Dp21 and Bst22 and the amplitude of the pressure vibration that each waveform imparts to the pressure chamber. The amplitude of the pressure vibration that each waveform imparts to the pressure chamber varies not only with the waveform width, but also with the voltage height of each waveform, rise and fall times such as tr and tf, and intermediate voltage times such as Tma and Tmb. However, FIGS. 13 to 16 schematically illustrate a change in the amplitude of the pressure vibration applied to the pressure chamber 46, which is mainly caused by a difference in the waveform width between the ejection waveform width Dp21 of the first drop and the waveform width Bst22 of the Bst width, assuming that the voltage height of each waveform is the same, and the rise and fall times such as tr and tf and the intermediate voltage times such as Tma and Tmb are also shorter than AL.

For example, as illustrated in FIG. 14C, when the pressure chamber 46 in which the half period of the main acoustic vibration is maxAL is driven with a waveform in which Dp21 is the average AL (avrAL) and Bst22 is shorter than the average AL (Dp21=avrAL, Bst22<avrAL), the decrease in the amplitude of the pressure vibration due to Bst22 is greater than the decrease in the amplitude of the pressure vibration due to Dp21, and there is a concern that the residual vibration generated by Dp21 cannot be completely canceled out by Bst22. In this case, the residual vibration generated by Dp21 weakens the ejection force of Dp22 at the timing when Dp22 is input, and therefore, the ejection force of droplet by Dp22 may be insufficient due to the influence of Dp21, and the ejection speed of the second drop may be lower than the ejection speed of the first drop.

Further, as illustrated in FIG. 14A, when the pressure chamber 46 in which the half period of the main acoustic vibration is minAL is driven with a waveform in which Dp21<average AL and Bst22=average AL (Dp21<avrAL, Bst22=avrAL), the amplitude of the pressure vibration due to Dp21 increases while the amplitude of the pressure vibration due to Bst22 decreases. For this reason, there is a concern that the residual vibration generated by Dp21 cannot be completely canceled out by Bst22. In this case, the residual vibration generated by Dp21 also weakens the ejection force of Dp22 at the timing when Dp22 is input, and therefore, the ejection force of droplet by Dp22 may be insufficient due to the influence of Dp21, and the ejection speed of the second drop may be lower than the ejection speed of the first drop.

The above concerns the waveform widths of Dp21 and Bst22 of the 2-drop waveform, but similar concerns may arise regarding the waveform widths of Dp32 and Bst33 of the 3-drop waveform, depending on the liquid viscosity in the pressure chamber and the flow path resistance of the head.

Next, a case where the ejection waveform width Dp21 for the first drop and the waveform width Bst22 of the Bst width are the same in the 2-drop waveform will be considered. For example, as illustrated in FIG. 16C, when the pressure chamber in which the half period of the main acoustic vibration is maxAL is driven with a waveform in which Dp21=Bst22, the decrease in the amplitude of the pressure vibration due to Dp21 is substantially the same as the decrease in the amplitude of the pressure vibration due to Bst22.

Here, when tr or tf of Bst22 is shorter than tf or tr of Dp21, the pressure vibration generated by Bst22 becomes greater than the pressure vibration generated by Dp21, and the residual vibration by Dp21 is canceled out. In addition, when the Bst voltage height of Bst22 is higher than the ejection voltage height of Dp21, the pressure vibration generated by Bst22 becomes greater than the pressure vibration generated by Dp21, and the residual vibration by Dp21 is canceled out.

When the intermediate voltage time of Bst22 is shorter than the intermediate voltage time Tm21a or Tm21b of Dp21, the pressure vibration generated by Bst22 becomes greater than the pressure vibration generated by Dp21, and the residual vibration by Dp21 is canceled out. As described above, if the pressure vibration generated by Bst22 is greater than the pressure vibration generated by Dp21, the residual vibration generated by Bst22 strengthens the pressure vibration of the ejection waveform Dp22 input after the time of BD22.

When the speed of the droplet ejected by a drive waveform including only the ejection waveform of Dp22 alone is lower than the ejection speed of the droplet of the second drop ejected by the ejection waveform of Dp22 of the 2-drop waveform, the pressure vibration generated by Bst22 of the corresponding 2-drop waveform is greater than the residual vibration generated by Dp21, and it can be considered that the residual vibration generated after Bst22 strengthens the pressure vibration of the ejection waveform Dp22 input after the time of BD22. Further, the waveform width, the ejection voltage heights tf and tr, the intermediate voltage time, and the like of the ejection waveform of Dp22 alone are set to values that make the ejection force equal to or less than that of the 1-drop waveform. In this case, if the droplet ejected by Dp22 or a combined droplet of the droplet ejected by Dp21 and the droplet ejected by Dp22 has the same speed as the droplet ejected by the 1-drop waveform, the pressure vibration generated by Bst22 is greater than the residual vibration generated by Dp21, and it can be considered that the residual vibration generated after Bst22 strengthens the pressure vibration of the ejection waveform Dp22 input after the time of BD22.

Here, if the pressure chamber in which the half period of the main acoustic vibration is maxAL is driven with a waveform in which the waveform width of Dp22 is shorter than that of Dp21 or Bst22, the decrease in the amplitude of the pressure vibration due to Dp22 becomes greater than the decrease in the amplitude of the pressure vibration due to Dp21 or Bst22, and the ejection speed of the second drop may become lower than the ejection speed of the first drop. Therefore, Dp22=Dp21=Bst22 is more preferably set.

As a result, the decrease in the amplitude of the pressure vibration due to Dp22 is substantially the same as the decrease in the amplitude of the pressure vibration due to Dp21 or Bst22, and even when driving the pressure chamber 46 in which the half period of the main acoustic vibration is maxAL, a state in which the ejection speed of the second drop is greater than the ejection speed of the first drop is maintained.

Similarly, in driving the pressure chamber 46 in which the half period of the main acoustic vibration is minAL, by setting Dp21=Bst22, the decrease in the amplitude of the pressure vibration due to Dp21 becomes substantially the same as the decrease in the amplitude of the pressure vibration due to Bst22, and the residual vibration of Dp21 is canceled out by the pressure vibration of Bst22. Further, if the pressure vibration generated by Bst22 is greater than the pressure vibration generated by Dp21, the residual vibration generated by Bst22 strengthens the pressure vibration of the ejection waveform Dp22 input after the time of BD22.

If the pressure chamber in which the half period of the main acoustic vibration is minAL is driven with a waveform in which the waveform width of Dp22 is longer than that of Dp21 or Bst22, the decrease in the amplitude of the pressure vibration due to Dp22 becomes greater than the decrease in the amplitude of the pressure vibration due to Dp21 or Bst22, and the ejection speed of the second drop may become lower than the ejection speed of the first drop. Therefore, Dp22=Dp21=Bst22 is more preferably set.

When droplets are ejected by Dp22, the pressure vibration is strengthened by Bst22, so that even if the pressure vibration by Dp22 is weaker than the pressure vibration by Dp21, the ejection speed of the second drop can be greater than the ejection speed of the first drop. However, to more reliably maintain the state in which the ejection speed of the second drop is greater than the ejection speed of the first drop, the tr and tf of Dp22 can be made shorter than tr and tf of Dp21, or the ejection voltage height of Dp22 can be made higher than the ejection voltage height of Dp21, or the intermediate voltage time Tm22a or Tm22b of Dp22 can be made shorter than the intermediate voltage time Tm21a or Tm21b of Dp21.

Similarly, for the waveform widths of Dp31, Dp32, Bst33, and Dp33 of the 3-drop waveform, it is desirable to set the waveform widths to Dp31=Dp32=Bst33=Dp33 so that the decrease in the amplitude of the pressure vibration due to the change in the half period of the main acoustic vibration is substantially the same for the waveforms of Dp31, Dp32, Bst33, and Dp33.

Next, the ejection speeds of the 2-drop waveform and the 1-drop waveform when the value of Dp22=Dp21=Bst22 is larger than minAL and smaller than maxAL will be considered. In the 1-drop waveform as shown in FIGS. 9 and 12, the pressure vibration by only the ejection waveform of Dp11 is required to make the ejection speed equal to that of the ejection droplet of the 2-drop waveform, and therefore, Dp11=average AL.

Here, in the pressure chamber in which the half period of the main acoustic vibration is minAL, the speed of the droplet ejected with the 2-drop waveform in which the value of Dp22=Dp21=Bst22 is minAL may be greater than the speed of the droplet ejected with the 1-drop waveform in which Dp11=average AL. Further, in the pressure chamber in which the half period of the main acoustic vibration is maxAL, the speed of the droplet ejected with the 2-drop waveform in which the value of Dp22=Dp21=Bst22 is maxAL may also be greater than the speed of the droplet ejected with the 1-drop waveform in which Dp11=average AL. When the value of Dp22=Dp21=Bst22 is greater than minAL and smaller than maxAL, the same concern arises in any one of the pressure chambers with the half period of the main acoustic vibration between minAL and maxAL.

Therefore, in consideration of reducing the difference in speed of droplets between the 2-drop waveform and the 1-drop waveform, it is desirable to set the value of Dp22=Dp21=Bst22 smaller than minAL or greater than maxAL.

Similarly, in the case of the 3-drop waveform, in consideration of reducing the difference in speed of droplets between the 3-drop waveform and the 1-drop waveform, it is desirable to set the value of Dp31=Dp32=Bst33=Dp33 smaller than minAL or greater than maxAL.

Next, in the examples of FIGS. 5 and 7, specific examples of adjustment of the waveform widths of the 3-drop waveform and the 2-drop waveform, the ejection voltage height, and the Bst voltage height will be described. First, the head is driven with the 1-drop waveform, and the ejection speed in response to voltage changes in the falling waveforms (1) and (2) is measured. The voltage change (for example, 14 V) of the falling waveforms (1) and (2) that results in the necessary ejection speed (for example, 7 m/s) is set as the ejection voltage height, and thereafter, the 3-drop waveform and the 2-drop waveform are adjusted at the same ejection voltage height.

Next, the waveform width of the 3-drop waveform Dp31 (=Dp32=Bst33=Dp33) is tentatively determined in the range of 0.5AL to 1AL. Here, 0.75AL is set as the waveform width of Dp31 (=Dp32=Bst33=Dp33). Here, the Bst voltage height is tentatively set to the same voltage as the ejection voltage height, and the relationship between the ejection speed of each droplet ejected by the 3-drop waveform and the Bst voltage height is measured. Here, the Bst voltage height at which the ejection speed of the third drop is greater than that of the first drop and the second drop in the 3-drop waveform is determined, and the voltage is set as the Bst voltage height (for example, 14 V).

Next, the relationship between the ejection speed of each droplet ejected by the 3-drop waveform and the waveform width of Dp31 (=Dp32=Bst33=Dp33) is measured. Here, the waveform width of Dp31 (=Dp32=Bst33=Dp33) at which the ejection speed of any one of the first drop, the second drop, or the third drop of the 3-drop waveform, or the ejection speed of the combined droplet of the first drop, the second drop, and the third drop becomes substantially the same as the speed (for example, 7 m/s) of the droplet ejected with the 1-drop waveform is determined, and the waveform width is set to the waveform width of Dp31 (=Dp32=Bst33=Dp33) of the 3-drop waveform (for example, 0.65AL). Since each voltage height and each waveform width are determined by this, a cancellation waveform may be added after the ejection waveform of the third drop to reduce the residual vibration remaining in the pressure chamber after the third drop.

Next, in the example of FIG. 7, adjustment of the 2-drop waveform will be described. The ejection voltage height and Bst voltage height of the 2-drop waveform are the same as the ejection voltage height and Bst voltage height of the 3-drop waveform. First, the relationship between the ejection speed of each droplet ejected by the 2-drop waveform and the waveform width of Dp21 (=Bst22=Dp22) is measured. Here, the waveform width of Dp21 (=Bst22=Dp22) at which the ejection speed of any one of the first drop or the second drop of the 2-drop waveform, or the ejection speed of the combined droplet of the first drop and the second drop becomes substantially the same as the speed (for example, 7 m/s) of the droplet ejected with the 1-drop waveform is determined, and the waveform width is set to the waveform width of Dp21 (=Bst22=Dp22) of the 2-drop waveform (for example, 0.72AL). Since each voltage height and each waveform width are determined by this, it is only necessary to adjust a cancellation waveform after the ejection waveform of the second drop to reduce the residual vibration remaining in the pressure chamber after the second drop.

When a liquid having a low viscosity is ejected with the 3-drop waveform of FIG. 5, a large residual vibration is generated after the second drop is ejected, and the Bst voltage height may be increased in order to cancel the residual vibration. Here, the ejection waveform having a width of Dp33 is input immediately after the waveform having a width of Bst33, but if the Bst voltage height is large, a large negative pressure is generated in the pressure chamber, which may cause entrainment of air bubbles. In this case, it is sufficient to reduce the residual vibration due to the ejection waveforms of the first and second drops.

For example, in the drive circuit 70, a voltage source (for example, the fifth voltage source 85) having a voltage intermediate between the ejection voltage heights is set to the voltage height of the ejection waveforms for the first drop and the second drop. Alternatively, as shown in FIG. 6, the ejection waveforms for the first drop and the second drop are configured as stepped waveforms that wait a certain time at an intermediate voltage before changing to the next voltage, and by adjusting the waiting time, the amplitude of the pressure vibrations applied to the pressure chamber 46 by the ejection waveforms for the first drop and the second drop is adjusted, thereby reducing the residual vibration after the ejection of the first drop and the second drop. Alternatively, the fall time tf and rise time tr of the ejection waveform for the first drop and second drop are set longer than the fall time tf and rise time tr of the waveform having the Bst width and the ejection waveform for the third drop. For example, when the actuator 20 is regarded as a capacitor and a wiring circuit connecting the voltage source and the actuator is regarded as a CR series circuit, the time constant for voltage rise and voltage fall can be changed by changing the resistance R in the circuit wiring. Since the waveform width Dp31 of the first drop is set to be substantially the same as the waveform width Dp32 of the second drop, even in a pressure chamber in which the half period of the main acoustic vibration is different from AL, the decrease in the amplitude of the pressure vibration due to Dp31 is substantially the same as that of Dp32, and the change in the magnitude relationship between the ejection speeds of the first drop and the second drop of the 3-drop waveform can be suppressed.

The following describes an example of adjusting the 3-drop waveform and the 2-drop waveform when the ejection waveforms of the first drop and the second drop are stepwise with reference to FIG. 6. The 1-drop waveform is the same as described above, and the necessary ejection speed (for example, 7 m/s), the voltage change of the falling waveforms (1) and (2), and the voltage change (for example, 14 V) of the rising waveforms (3) and (4) are of the same height. The intermediate voltage time of the 3-drop waveform and the intermediate voltage time of the 2-drop waveform are all set to be the same (for example, Tm31a=Tm31b=Tm32a=Tm32b=Tm21a=Tm21b=0.3AL).

First, the waveform width of the 3-drop waveform Dp31 (=Dp32=Bst33=Dp33) is tentatively determined in the range of 0.5AL to 1AL. Here, 0.75AL is set as the waveform width of Dp31 (=Dp32=Bst33=Dp33). Here, the Bst voltage height is tentatively set to the same voltage as the ejection voltage height, and the relationship between the ejection speed of each droplet ejected by the 3-drop waveform and the Bst voltage height is measured. Here, the Bst voltage height at which the ejection speed of the third drop is greater than that of the first drop and the second drop in the 3-drop waveform is determined, and the voltage is set as the Bst voltage height (for example, 10.5 V).

Next, the relationship between the ejection speed of each droplet ejected by the 3-drop waveform and the waveform width of Dp31 (=Dp32=Bst33=Dp33) is measured. Here, the waveform width of Dp31 (=Dp32=Bst33=Dp33) at which the ejection speed of any one of the first drop, the second drop, or the third drop of the 3-drop waveform, or the ejection speed of the combined droplet of the first drop, the second drop, and the third drop becomes substantially the same as the speed (for example, 7 m/s) of the droplet ejected with the 1-drop waveform is determined, and the waveform width is set to the waveform width of Dp31 (=Dp32=Bst33=Dp33) of the 3-drop waveform (for example, 0.75AL). Since each voltage height and each waveform width are determined by this, a cancellation waveform may be added after the ejection waveform of the third drop to reduce the residual vibration remaining in the pressure chamber after the third drop.

Next, as shown in FIG. 8, the adjustment when the first drop is stepwise in the 2-drop waveform will be described. The ejection voltage height and Bst voltage height of the 2-drop waveform are the same as the ejection voltage height and Bst voltage height of the 3-drop waveform. First, the relationship between the ejection speed of each droplet ejected by the 2-drop waveform and the waveform width of Dp21 (=Bst22=Dp22) is measured. Here, the waveform width of Dp21 (=Bst22=Dp22) at which the ejection speed of any one of the first drop or the second drop of the 2-drop waveform, or the ejection speed of the combined droplet of the first drop and the second drop becomes substantially the same as the speed (for example, 7 m/s) of the droplet ejected with the 1-drop waveform is determined, and the waveform width is set to the waveform width of Dp21 (=Bst22=Dp22) of the 2-drop waveform (for example, 0.78AL). Since each voltage height and each waveform width are determined by this, it is only necessary to adjust a cancellation waveform after the ejection waveform of the second drop to reduce the residual vibration remaining in the pressure chamber after the second drop.

In the example described above, the 3-drop waveform in FIG. 6 is described as having a stepped ejection waveform for the first drop and the second drop. Additionally, as in the 3-drop waveform in FIG. 10, the waveform having the Bst width and the ejection waveform for the third drop may also be stepped. It is desirable that the intermediate voltage time of the waveform having the width of Bst and the ejection waveform for the third drop is shorter than the intermediate voltage time of the ejection waveforms for the first drop and the second drop, and that the amplitude of the pressure vibration that the waveform having the width of Bst and the ejection waveform for the third drop impart to the pressure chamber 46 is greater than the amplitude of the pressure vibration that the ejection waveforms for the first drop and the second drop impart to the pressure chamber 46.

Similarly, in the 2-drop waveform, the waveform having the width of Bst and the ejection waveform for the second drop may also be formed in a stepped shape as in the 2-drop waveform in FIG. 11. It is desirable that the intermediate voltage time of the waveform having the width of Bst and the ejection waveform for the second drop is shorter than the intermediate voltage time of the ejection waveform for the first drop, and that the amplitude of the pressure vibration that the waveform having the width of Bst and the ejection waveform for the second drop impart to the pressure chamber 46 is greater than the amplitude of the pressure vibration that the ejection waveform for the first drop imparts to the pressure chamber 46.

Even in a case where it is desirable to set Dp21, Bst22, and Dp22 to different values in order to finely adjust the speed of each droplet of the 2-drop waveform, it is desirable to set Dp21, Bst22, and Dp22 to values that are as close as possible so that the pressure applied to the liquid in the pressure chamber 46 by Dp21, Bst22, and Dp22 is similar. For example, the time difference between Dp21, Bst22, and Dp22 is desirably a minimum time difference other than the time difference of zero that can be set in the drive circuit 70 that generates the drive waveform.

For example, if the 2-drop waveform is Dp21=Bst22=Dp22=2.34 μs and UL=3.0 μs, a speed of a combined droplet by the 2-drop waveform is higher than a speed of the ejection droplet of the 1-drop waveform, and if the 3-drop waveform is Dp31=Dp32=Dp33=2.32 μs and UL=3.0 μs, a speed of the combined droplet by the 3-drop waveform is lower than the speed of the ejection droplet of the 1-drop waveform.

In the drive circuit 70 of the liquid ejection head 1, if the values of Dp21, Bst22, and Dp22 cannot be set to values between 2.34 μs and 2.32 μs, for example, Dp21=Bst22=2.32 μs, Dp22=2.34 μs, and UL=3.0 μs may be used, or Dp21=2.34 μs, Bst22=Dp22=2.32 μs, and UL=3.0 μs may be used.

Similarly, even if it is desirable to set Dp31, Dp32, Bst33, and Dp33 to different values in order to finely adjust the speed of each droplet of the 3-drop waveform, it is desirable to set Dp31, Dp32, Bst33, and Dp33 to values that are as close as possible so that the pressure applied to the liquid in the pressure chamber 46 by Dp31, Dp32, Bst33, and Dp33 is similar. For example, the time difference between Dp31, Dp32, Bst33, and Dp33 is desirably a minimum time difference other than the time difference of zero that can be set in the drive circuit 70 that generates the drive waveform.

For example, if the 3-drop waveform is Dp31=Dp32=Bst33=Dp33=2.26 μs and UL=3.0 μs, a speed of a combined droplet by the 3-drop waveform is higher than a speed of the ejection droplet of the 1-drop waveform, and if the 3-drop waveform is Dp31=Dp32=Bst33=Dp33=2.24 μs and UL=3.0 μs, a speed of the combined droplet by the 3-drop waveform is lower than the speed of the ejection droplet of the 1-drop waveform.

In the drive circuit 70 of the liquid ejection head 1, if the values of Dp31, Dp32, Bst33, and Dp33 cannot be set to values between 2.26 μs and 2.24 μs, for example, Dp31=Dp32=Bst33=2.24 μs, Dp33=2.26 μs, and UL=3.0 μs may be used, or Dp31=Dp32=2.26 μs, Bst33=Dp33=2.24 μs, and UL=3.0 μs may be used.

Next, with reference to FIG. 11, conditions for canceling out residual vibration generated by the ejection waveform having the width of Dp21 using a waveform having the width of Bst22 will be described.

When the period of the acoustic resonance frequency of the pressure chamber is 2AL, the vibration period generated by an ejection waveform that generates a negative pressure and then a positive pressure, such as Dp21, is also 2AL. The phase of the composite wave of the negative pressure and positive pressure is −π/2 at the midpoint between the time when the negative pressure is generated and the time when the positive pressure is generated. In the case of a waveform that generates a positive pressure and then a negative pressure, as in Bst22, the phase of the composite wave of the positive pressure and negative pressure is ½ at the midpoint between the time when the positive pressure is generated and the time when the negative pressure is generated. If an interval between the center of the waveform width of Dp21 and the center of the waveform width of Bst22 is 2UL and is made to coincide with 2AL, the pressure vibrations generated by both will weaken each other.

When the Dp21 width and the Bst22 width are the same, the time interval between the midpoint of (1) and (2) and the midpoint of (b21) and (b22) is also 2UL. Similarly, the time interval between the midpoint of (3) and (4) and the midpoint of (b23) and (b24) is also 2UL.

Here, the amplitude of a composite wave vector Da″ of the falling waveforms (1) and (2) at the midpoint of (b21) and (b22) is |Da″|, and the phase is φDa″.

Next, assuming that a composite wave vector of the rising waveforms (b21) and (b22) at the midpoint of (b21) and (b22) is defined as Ba″, the amplitude thereof is |Ba″ | and the phase thereof is φBa″, then Da″=|Da″| (cos φDa″, sin φDa″) and Ba″=|Ba″|(cos φBa″, sin φBa″).

Here, a condition under which the absolute value of the composite vector of Da″ and Ba″ is equal to or less than the greater of the absolute values of Da″ and Ba″ (or less than the greater of the absolute values of Da″ and Ba″ if the absolute values of Da″ and Ba″ are the same) is considered.

In this case, the absolute value of the composite vector of Da″ and Ba″ is given, from the formula for the composition of simple harmonic motion and the addition theorem, by

$$\sqrt{{\vert {Da}^{″} \vert}^{2} + {\vert {Ba}^{″} \vert}^{2} + 2 \vert {Da}^{″} \vert * \vert {Ba}^{″} \vert * cos ( φ {Da}^{″} - φ {Ba}^{″} )} . \qquad ( Expression 1 )$$

If |Da″|≤|Ba″|, the phase difference between Da″ and Ba″ (φDa″−φBa″) for which |Ba″ |≥Expression 1 holds is the condition for the vibrations of period 2AL generated by Da″ and Ba″ to weaken each other. By squaring both sides of |Ba″|≥Expression 1 and transforming it,

$$0 \geq \vert {Da}^{″} \vert + 2 * \vert {Ba}^{″} \vert * cos ( φ {Da}^{″} - φ {Ba}^{″} ) \qquad ( Expression 2 )$$

is obtained. From the above, if the phase difference between Da″ and Ba″ (φDa″−φBa″) is within the range of 180°±60°, Expression 2 holds.

In addition, when |Da″ |≥|Ba″|, by squaring both sides of |Da″|≥Expression 1 and transforming it, 0≥|Ba″|+2*|Da″|*cos (φDa″−φBa″) (Expression 3). From the above, if the phase difference between Da″ and Ba″ (φDa″−φBa″) is within the range of 180°±60°, Expression 3 holds.

The phases of the pressure vibrations generated by the rising waveforms (b21) and (b22) are both zero, and if the amplitudes of (b21) and (b22) are also substantially the same, the phase φBa″ becomes zero.

The phases of the pressure vibrations generated by the falling waveforms (1) and (2) are both −π, and if the amplitudes of (1) and (2) are also substantially the same, the phase of the composite wave vector of (1) and (2) at the midpoint of (1) and (2) is −π, and the phase Da″ of Da″ after a time lapse of 2UL therefrom is −π+2UL*(π/AL). Therefore, 2UL in which the phase difference (φDa″−φBa″) is in the range of 180°±60° is in the range from (k−1/6)2AL to (k±1/6)2AL. Note that k is a natural number.

When considering that the residual vibration generated by Bst22 strengthens the pressure vibration of the ejection waveform Dp22 input after the time of BD22, it is desirable that |Da″ |≤|Ba″|.

In addition, the phase difference between the pressure vibrations generated by the rising waveforms (3) and (4) and the pressure vibrations generated by the falling waveforms (b23) and (b24) is also ±π, and the time interval between the midpoint of (3) and (4) and the midpoint of (b23) and (b24) is also 2UL. If 2UL is in the range from (k−1/6)2AL to (k+1/6)2AL, the pressure vibrations with a period of 2AL generated by (3) and (4) and the pressure vibrations with a period of 2AL generated by (b23) and (b24) weaken each other. Note that k is a natural number. The amplitude of the composite wave vector Db″ of the rising waveforms (3) and (4) at the midpoint of (b23) and (b24) is assumed to be |Db″|, and the amplitude of the composite wave vector Bb″ of the falling waveforms (b23) and (b24) at the midpoint of (b23) and (b24) is assumed to be |Bb″|. When considering that the residual vibration generated by Bst22 strengthens the pressure vibration of the ejection waveform Dp22 input after the time of BD22, it is desirable that |Db″ |≤|Bb″|.

Further, considering that the phase of the composite wave of the pressure vibration generated by Dp21 is −π/2 at the center of the Dp21 width and the phase of the composite wave of the pressure vibration generated by Bst22 is π/2 at the center of the Bst22 width, the phase difference between the two pressure vibrations is also ±π, and the interval between the center of the waveform width of Dp21 and the center of the waveform width of Bst22 is 2UL. If 2UL is in the range from (k−1/6)2AL to (k+1/6)2AL, the pressure vibration with a period of 2AL generated by Dp21 and the pressure vibration with a period of 2AL generated by Bst22 weaken each other. When considering that the residual vibration generated by Bst22 strengthens the pressure vibration of the ejection waveform Dp22 input after the time of BD22, the amplitude of the pressure vibration with a period of 2AL generated by Bst22 is necessarily greater than the amplitude of the pressure vibration with a period of 2AL generated by Dp21 at the time of input of Bst22.

The same applies to the conditions for canceling out the residual vibration generated by the ejection waveform having the width of Dp32 in FIG. 10 using the waveform having the width of Bst33. The interval between the center of the waveform width of Dp32 and the center of the waveform width of Bst33 is 2UL. If 2UL is in the range from (k−1/6)2AL to (k+1/6)2AL, the pressure vibration with a period of 2AL generated by Dp32 and the pressure vibration with a period of 2AL generated by Bst33 weaken each other. When considering that the residual vibration generated by Bst33 strengthens the pressure vibration of the ejection waveform Dp33 input after the time of BD33, the amplitude of the pressure vibration with a period of 2AL generated by Bst33 is necessarily greater than the amplitude of the pressure vibration with a period of 2AL generated by Dp32 at the time of input of Bst33.

As described above, the drive waveform of the liquid ejection head 1 according to the embodiment has a configuration in which a plurality of ejection waveforms are provided to eject a plurality of droplets, and in the process of ejecting all droplets, a waveform that cancels out the residual vibration of the main acoustic vibration is input to reduce the disturbance of the shape of the meniscus, and then the remaining droplets are ejected. As a specific example, the drive waveform of the liquid ejection head 1 is configured such that, immediately before the last ejection waveform of the plurality of droplets, a waveform (boost waveform) that cancels out the residual vibration of the main acoustic vibration of one or more ejection waveforms input before the last ejection waveform is input to reduce disturbance of the shape of the meniscus, and then the remaining droplets are ejected. Further, the drive waveform is configured such that, immediately after the boost waveform that cancels out the residual vibration of the main acoustic vibration, the ejection waveform for ejecting the last droplet is input at a timing at which the boost waveform that cancels out the residual vibration and the vibration in the pressure chamber 46 intensify each other.

The boost waveform that cancels out the residual vibration is a waveform that generates in the pressure chamber 46 a vibration that is greater than the residual vibration of the main acoustic vibration generated in the pressure chamber 46 by the input of the ejection waveform prior to the input of the boost waveform. As a result, the boost waveform that cancels out the residual vibration functions as a waveform that increases the ejection force of the ejection waveform for executing the remaining droplet ejection and is input immediately after the input boost waveform.

That is, in the related art, as a method for adjusting the strength of the vibration applied to a pressure chamber by the ejection waveform, a waveform that cancels out residual vibration, or a boost waveform, a method is adopted in which the waveform width is adjusted individually such that each droplet has a desired speed, for example, such that the speed gradually increases when the droplets are continuously ejected. However, if there is variation in the main acoustic vibration period among a plurality of pressure chambers, the ratio of the period of the main acoustic vibration of each pressure chamber to the width of the ejection waveform of each droplet varies for each pressure chamber. For this reason, depending on the period of the main acoustic vibration of the pressure chamber, there are cases where continuously ejected droplets do not combine, which causes deterioration of printing quality.

The drive waveform of the liquid ejection head 1 according to the present embodiment is input to the plurality of pressure chambers 46, and is configured such that the waveform widths of the ejection waveform and the boost waveform are the same in the same drive waveform for continuously ejecting a plurality of droplets. As a result, even if there is variation in the main acoustic vibration periods of the plurality of pressure chambers 46, the magnitude relationship between the speeds of the plurality of droplets that are continuously ejected can be suppressed.

The magnitude of the vibration generated in the pressure chamber 46 by a waveform that cancels out the residual vibration of the main acoustic vibration generated in the pressure chamber 46 due to the input of an intermediate ejection waveform among a plurality of ejection waveforms, in other words, a boost waveform that is input immediately thereafter to increase the ejection force of the ejection waveform that ejects the remaining droplets among the plurality of droplets, is adjusted. The magnitude of the vibration generated in the pressure chamber 46 by the boost waveform is adjusted, for example, by a ratio of the voltage height between the boost waveform and the ejection waveform input before the boost waveform (before the boost waveform is input). Further, for example, the magnitude of the vibration generated in the pressure chamber 46 by the boost waveform is adjusted by a difference in the intermediate voltage time between the boost waveform and the ejection waveform input before the boost waveform. Further, for example, the magnitude of the vibration generated in the pressure chamber 46 by the boost waveform is adjusted by a difference in the rise time and the fall time when the voltage of the boost waveform and the ejection waveform input before the boost waveform is changed.

As described above, according to the liquid ejection head 1 of the embodiment, in the drive waveform for ejecting a plurality of droplets, a waveform (boost waveform) that cancels out the residual vibration due to the ejection waveform input previously and generates vibration greater than the residual vibration in the pressure chamber 46 is input in the middle of the plurality of ejection waveforms. The waveform (boost waveform) that cancels out the residual vibration increases the ejection force (amplitude) of the ejection waveform that is input after the waveform that cancels out the residual vibration. As a result, the speed of the droplet ejected by the ejection waveform input immediately after the waveform (boost waveform) that reduces residual vibration becomes greater than the speed of the droplet ejected by the ejection waveform before the input of the boost waveform. As described above, the liquid ejection head 1 can reduce the disturbance of the shape of the meniscus even when ejecting a plurality of droplets by inputting the boost waveform in the middle of the drive waveform for ejecting the plurality of droplets. Therefore, the liquid ejection head 1 can suppress deterioration of the printing quality even if the viscosity of the liquid to be ejected is low.

According to the liquid ejection head of at least one embodiment described above, by inputting a boost waveform in the middle of a plurality of ejection waveforms, the residual vibration generated by the ejection waveform is canceled out, and the ejection force of the ejection waveform after the boost waveform is increased, thereby reducing disturbance of the shape of the meniscus even when a plurality of droplets are ejected.

While certain embodiments have been described, these embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying embodiments and their equivalents are intended to cover such forms or modifications as would fall within the scope and spirit of the disclosure.

What is claimed is:

1. A liquid ejection head comprising:
a nozzle plate having a nozzle through which liquid is ejected;
a pressure chamber communicating with the nozzle;
an actuator configured to change a volume of the pressure chamber in response to a drive signal; and
a drive circuit configured to generate the drive signal, wherein
the drive signal includes:
two ejection waveforms for causing the nozzle to eject two droplets, the ejection waveforms including a first ejection waveform and a second ejection waveform that is input after the first ejection waveform, and
a suppression waveform that is input between the first and second ejection waveforms and suppresses residual vibration generated by the first ejection waveform,
the second ejection waveform is input at a timing at which vibration generated by the first ejection waveform and vibration generated by the suppression waveform intensify each other, and
a speed of a droplet ejected by the second ejection waveform is greater than a speed of a droplet ejected by the first ejection waveform.

2. The liquid ejection head according to claim 1, wherein a waveform width of the suppression waveform is substantially the same as a waveform width of the first ejection waveform.

3. The liquid ejection head according to claim 1, wherein waveform widths of the suppression waveform and the first and second ejection waveforms are shorter than a minimum value of a half period of main acoustic vibration of the pressure chamber, or are longer than a maximum value of the half period of the main acoustic vibration of the pressure chamber.

4. The liquid ejection head according to claim 1, wherein an intermediate voltage time of the suppression waveform is shorter than an intermediate voltage time of the first ejection waveform.

5. The liquid ejection head according to claim 1, wherein a rise time and a fall time of the suppression waveform are shorter than a rise time and a fall time of the first ejection waveform.

6. The liquid ejection head according to claim 1, wherein the suppression waveform has a polarity different from a polarity of the ejection waveforms with respect to a reference potential.

7. The liquid ejection head according to claim 1, wherein
the first ejection waveform is a stepped waveform that includes an intermediate voltage portion in which a voltage is maintained at an intermediate potential between a reference potential and a peak potential of the first ejection waveform for a predetermined time.

8. The liquid ejection head according to claim 1, wherein the drive signal further includes a cancellation waveform that is input after the second ejection waveform and suppresses residual vibration generated by the second ejection waveform.

9. The liquid ejection head according to claim 8, wherein the cancellation waveform is a stepped waveform including an intermediate voltage portion in which a voltage is maintained at an intermediate potential for a predetermined time.

10. The liquid ejection head according to claim 1, wherein
each of the first ejection waveform and the suppression waveform is a stepped waveform, and
an intermediate voltage time of the suppression waveform is shorter than an intermediate voltage time of the first ejection waveform.

11. The liquid ejection head according to claim 10, wherein
the second ejection waveform is a stepped waveform, and
an intermediate voltage time of the second ejection waveform is shorter than the intermediate voltage time of the first ejection waveform.

12. The liquid ejection head according to claim 10, wherein the drive signal further includes a cancellation waveform that is input after the second ejection waveform and suppresses residual vibration generated by the second ejection waveform.

13. The liquid ejection head according to claim 12, wherein
the cancellation waveform is a stepped waveform, and
an intermediate voltage time of the cancellation waveform is longer than the intermediate voltage time of the second ejection waveform.

14. The liquid ejection head according to claim 1, wherein a voltage height of the suppression waveform is higher than a voltage height of the first ejection waveform.

15. The liquid ejection head according to claim 1, wherein
the drive circuit includes a voltage control unit and a plurality of voltage switching units, and
the voltage control unit is configured to control the plurality of voltage switching units to selectively connect the actuator to one of a plurality of voltage sources.

16. The liquid ejection head according to claim 15, wherein the plurality of voltage sources includes a first voltage source configured to output a reference voltage, a second voltage source configured to output a voltage higher than the reference voltage, and a third voltage source configured to output a voltage lower than the reference voltage.

17. The liquid ejection head according to claim 16, wherein the actuator includes a common electrode connected to the first voltage source and a plurality of individual electrodes connected to the plurality of voltage switching units, and the plurality of voltage switching units switch a connection between the plurality of individual electrodes and one of the first, second, or third voltage sources.

18. A liquid ejection device comprising:
a liquid ejection head for ejecting liquid onto a medium; and
a controller configured to control the liquid ejection head, wherein
the liquid ejection head includes:
a nozzle plate having a nozzle through which liquid is ejected,
a pressure chamber communicating with the nozzle,
an actuator configured to change a volume of the pressure chamber in response to a drive signal, and
a drive circuit configured to generate the drive signal, wherein
the drive signal includes:
two ejection waveforms for causing the nozzle to eject two droplets, the ejection waveforms including a first ejection waveform and a second ejection waveform that is input after the first ejection waveform, and
a suppression waveform that is input between the first and second ejection waveforms and suppresses residual vibration generated by the first ejection waveform,
the second ejection waveform is input at a timing at which vibration generated by the first ejection waveform and vibration generated by the suppression waveform intensify each other, and
a speed of a droplet ejected by the second ejection waveform is greater than a speed of a droplet ejected by the first ejection waveform.

19. The liquid ejection device according to claim 18, wherein a waveform width of the suppression waveform is substantially the same as a waveform width of the first ejection waveform.

20. The liquid ejection device according to claim 18, wherein waveform widths of the suppression waveform and the first and second ejection waveforms are shorter than a minimum value of a half period of main acoustic vibration of the pressure chamber, or are longer than a maximum value of the half period of the main acoustic vibration of the pressure chamber.
